(19) United States
(12) Patent Application Publication
(10) Pub. No.: US 2015/0222783 A1
(43) Pub. Date: Aug. 6, 2015

(54) SECURITY DOCUMENT, IMAGE FORMING APPARATUS-BASED SECURITY DOCUMENT MANAGEMENT SYSTEM, AND SECURITY DOCUMENT CREATION, MANAGEMENT, AND CERTIFICATION METHODS

(71) Applicant: SAMSUNG ELECTRONICS CO., LTD., Suwon-si (KR)

(72) Inventors: Chi Ho CHOI, Seoul (KR); Chun Sub RYU, Yongin-si (KR)

(73) Assignee: SAMSUNG ELECTRONICS CO., LTD., Suwon-si (KR)

(21) Appl. No.: 14/507,953

(22) Filed: Oct. 7, 2014

(30) Foreign Application Priority Data
Feb. 6, 2014 (KR) 10-2014-0013560

(51) Int. Cl. H04N 1/32; G06K 19/14; H04N 1/00; B42D 25/305

(52) U.S. Cl. CPC H04N 1/32138; B42D 25/305; G06K 19/145; H04N 1/00342; H04N 1/00328; H04N 2201/0082; H04N 2201/3269; H04N 2201/3235; H04N 2201/3239

(57) ABSTRACT

A security document with a high level of security fabricated at low cost by using an image forming apparatus-based security document management system is provided. The management system may include a near field communication (NFC) tag reader/writer, a method of managing a security document, a method of creating a security document, a method of certifying a security document, an image forming apparatus, and an image forming apparatus-based security document management system. A method of managing a security document by using an image forming apparatus including an NFC tag reader/writer may include an embodiment reading an integrated NFC tag of security paper including the integrated NFC tag by using the NFC tag reader/writer; performing a security document creation process for the security paper when a first S/N is stored in the NFC tag; and performing a security document certification process for the security document when the first S/N, a key value, and a second S/N are stored in the NFC tag.

### CROSS-REFERENCE TO RELATED APPLICATIONS

This application claims the priority benefit of Korean Patent Application No. 10-2014-0013560, filed on Feb. 6, 2014, in the Korean Intellectual Property Office, the disclosure of which is incorporated herein by reference.

### BACKGROUND

1. Field

Embodiments relate to image forming apparatuses, and more particularly, image forming apparatus-based security document management.

2. Description of the Related Art

Bar codes have widely been used to record information such as date of manufacture, expiration data, and sources, on objects formed of paper such as marketable securities, paper money, passports, gift certificates, security documents, and the like. However, since a bar code is limitedly configured as a form printed on paper, illegal use of bar codes has continued in various copied and counterfeited forms, in spite of using anti-copying or anti-counterfeiting members such as predetermined inks and holograms.

Alternatively, carrying out of a security document may be prevented by creating the security document by using security paper in which a metal component is embedded. However, although carrying out of a document in which a metal component is embedded may be prevented, the document is vulnerable to counterfeiting/tampering.

Alternatively, a copy of a security document cannot serve as a security document by allowing a security mark to disappear when the security document is copied. However, since the security mark needs to be visually checked, there may be a risk of misrecognition and the security document may easily be copied by scanning.

### SUMMARY

In an aspect of one or more embodiments, there is provided a security document with a high level of security fabricated at low cost by using an image forming apparatus-based security document management system which includes a near field communication (NFC) tag reader/writer, a method of managing a security document, a method of creating a security document, a method of certifying a security document, an image forming apparatus, and the image forming apparatus-based security document management system.

In an aspect of one or more embodiments, there is provided a security document includes an integrated near field communication (NFC) tag, wherein a first serial number (S/N), a key value, and a second S/N are stored as security certification information in the NFC tag.

In the security document, the 1st S/N may be a unique number of the NFC tag assigned by a manufacturer of the NFC tag.

In the security document, the 1st S/N may be a unique number of the NFC tag assigned by a user.

In the security document, the key value may be created by combining the 1st S/N with unique feature information of an image forming apparatus.

In the security document, the unique feature information of the image forming apparatus may include at least one selected from the group including a serial number of the image forming apparatus, a cumulative number of prints of the image forming apparatus, and creating time information of the security document in the image forming apparatus.

In the security document, the key value may be printed on a surface of the security document in at least one form selected from the group including a code including a combination of numbers and characters, a quick response (QR) code, and a bar code.

In the security document, the 2nd S/N may be created by combining the 1st S/N with the key value in accordance with one preset rule.

In the security document, the NFC tag may be an embedded type NFC tag.

In the security document, the NFC tag may be an attachment type NFC tag.

In an aspect of one or more embodiments, there is provided a method of managing a security document by using an image forming apparatus including an NFC tag reader/writer includes reading an integrated NFC tag of security paper including the integrated NFC tag by using the NFC tag reader/writer, performing a security document creation process for the security paper when the first S/N is stored in the NFC tag and both the key value and the second S/N are not stored in the NFC tag; and performing a security document certification process with respect to the security document when a 1st S/N (first serial number), a key value, and a 2nd S/N are stored in the NFC tag.

The security document management method may further include generating an image by scanning the security paper by using a scanner when the NFC tag is read by using the NFC tag reader/writer.

In the security document management method, the 1st S/N may be a unique number of the NFC tag assigned by a manufacturer of the NFC tag.

In the security document management method, the 1st S/N may be a unique number of the NFC tag assigned by a user.

In the security document management method, the key value may be created by combining the 1st S/N with unique feature information of the image forming apparatus.

In the security document management method, the unique feature information of the image forming apparatus may include at least one selected from the group including a serial number of the image forming apparatus, a cumulative number of prints of the image forming apparatus, and creating time information of the security document in the image forming apparatus.

In the security document management method, the key value may be printed on a surface of the security document in at least one form selected from the group including a code including a combination of numbers and characters, a QR code, and a bar code.

In the security document management method, the 2nd S/N may be created by combining the 1st S/N with the key value in accordance with one preset rule.

In the security document management method, the NFC tag may be an embedded type NFC tag.

In the security document management method, the NFC tag may be an attachment type NFC tag.

In the security document management method, the security document creation process may be performed by recording and storing security certification information in the NFC of the security document.

In the security document management method, the security document certification process may be performed by determining authenticity of the security document by analyzing security certification information stored in the NFC tag of the security document.

The security document management method may further include determining that the security document is an abnormal document when at least one selected from the 1st S/N, the key value, and the 2nd S/N is not stored in the NFC tag

In an aspect of one or more embodiments, there is provided a method of creating a security document by using an image forming apparatus which includes an NFC tag reader/writer includes acquiring a 1st S/N of an NFC tag by reading the NFC tag of security paper in which the NFC tag is embedded by using the NFC tag reader/writer, performing a security mode for creating a security document, creating a key value by combining the 1st S/N with unique feature information of the image forming apparatus, printing data and the key value on the security paper, acquiring the 1st S/N of the NFC tag by reading the NFC tag of the security paper on which the data and the key value are printed, and creating an image by scanning the security paper, comparing the 1st S/N acquired before performing the security mode with the 1st S/N acquired after performing the security mode, creating a 2nd S/N by combining the 1st S/N with the key value when the 1st S/N acquired before performing the security mode is the same as the 1st S/N acquired after performing the security mode, and storing the 2nd S/N and the key value in the NFC tag.

The security creation method may further include loading the security paper in a cassette feeder by a user, and generating an instruction to print data and the key value in the image forming apparatus for printing data and the key value on the security document.

The security creation method may further include placing the security paper on which the key value is printed on a scanner by a user, and generating an instruction to read the NFC tag in the image forming apparatus.

The security creation method may further include transmitting the key value and the image to a server.

The security creation method may further include determining that the security paper is an abnormal document when the 1st S/N acquired before performing the security mode is different from the 1st S/N acquired after performing the security mode.

In an aspect of one or more embodiments, there is provided a method of creating a security document by using an image forming apparatus including an NFC tag reader/writer which includes acquiring a 1st S/N of an NFC tag by reading the NFC tag of security paper to which the NFC tag is attached and on which data is printed by using the NFC tag reader/writer, performing a security mode for creating a security document, creating a key value by combining the 1st S/N with unique feature information of the image forming apparatus, acquiring the 1st S/N of the NFC tag by reading the NFC tag of the security paper, and creating an image by scanning the security paper, comparing the 1st S/N acquired before performing the security mode with the 1st S/N acquired after performing the security mode, creating a 2nd S/N by combining the 1st S/N with the key value when the 1st S/N acquired before performing the security mode is the same as the 1st S/N acquired after performing the security mode, and storing the 2nd S/N and the key value in the NFC tag.

The security creation method may further include placing the security paper on a scanner by a user, and generating an instruction to read the NFC tag in the image forming apparatus.

The security creation method may further include transmitting the key value and the image to a server.

The security creation method may further include determining that the security paper is an abnormal document when the 1st S/N acquired before performing the security mode is different from the 1st S/N acquired after performing the security mode.

In an aspect of one or more embodiments, there is provided a method of certifying a security document by using an image forming apparatus including an NFC tag reader/writer includes reading an integrated NFC tag of a security document including the integrated NFC tag by using the NFC tag reader/writer, scanning the security document, creating a temporary S/N by reversely combining a 1st S/N, a key value, and a 2nd S/N stored in the NFC tag, comparing the 1st S/N with the temporary S/N, displaying the key value when the 1st S/N is the same as the temporary S/N, confirming whether the key value stored in the NFC tag is the same as the displayed key value by using an application of a mobile terminal, confirming whether an image of the security document stored in a server is the same as an image of the security document acquired by newly scanning the security document, by using an application of the mobile terminal, when the key value stored in the NFC tag is the same as the displayed key value, and certifying that the security document is an original document when the image of the security document stored in the server is the same as the scanned image of the security document.

In the security document certification method, the confirming of the key value by using the application of the mobile terminal may include confirming the displayed key value by a user, executing the application by moving the mobile terminal in a direction toward the NFC tag of the security document, and inputting the displayed key value to the application of the mobile terminal.

In the security document certification method, the confirming of the displayed key value may be performed by confirming whether the key value printed on the security document is the same as the displayed key value.

In the security document certification method, the confirming of the key value by using the application of the mobile terminal may include comparing the image of the security document stored in the server with the scanned image of the security document, and marking a different portion using the image forming apparatus, and transmitting an image in which the different portion is marked by the image forming apparatus, to the mobile terminal of the user for confirmation by the user.

The security document certification method may further include manipulating a preset button of the image forming apparatus to inform the image forming apparatus that the user confirmed that the image of the security document stored in the server is the same as the scanned image of the security document.

In an aspect of one or more embodiments, there is provided a method of creating a security document by using an image forming apparatus including an NFC tag reader/writer includes acquiring a 1st S/N of an integrated NFC tag by reading the integrated NFC tag of security paper including the integrated NFC tag by using the NFC tag reader/writer, performing a security mode for creating a security document, creating a key value by combining the 1st S/N with unique feature information of the image forming apparatus, creating a 2nd SN by combining the 1st S/N with the key value, and storing the 2nd S/N and the key value in the NFC tag.

The security document creation method may further include transmitting the key value and an image to a server.

In an aspect of one or more embodiments, there is provided a method of certifying a security document by using an image forming apparatus which includes an NFC tag reader/writer includes scanning the security document while determining the existence of an integrated NFC tag in the security document including the integrated NFC tag, confirming, by using an application of a mobile terminal, whether an image of the security document stored in a server is the same as an image of the security document acquired by scanning the security document, and certifying that the security document is an original document when the image of the security document stored in the server is the same as the scanned image of the security document.

In the security document certification method, the confirming of the image by using the application of the mobile terminal may include comparing the image of the security document stored in the server with the scanned image of the security document, and marking a different portion using the image forming apparatus, and transmitting an image, in which the different portion is marked by the image forming apparatus, to the mobile terminal of the user for confirmation by the user.

The security document certification method may further include manipulating a preset button of the image forming apparatus to inform the image forming apparatus that the user confirmed that the image of the security document stored in the server is the same as the scanned image of the security document.

In an aspect of one or more embodiments, there is provided a method of certifying a security document by using an image forming apparatus including an NFC tag reader/writer includes acquiring a 1st S/N of an integrated NFC tag by reading the integrated NFC tag of a security document including the integrated NFC tag by using a mobile terminal, scanning the security document to obtain a scanned image of the security document, receiving an image of the security document stored in a server via an application of the mobile terminal and comparing the image with the security document, and certifying that the security document is an original document when the image of the security document stored in the server is the same as the scanned image of the security document.

The security document certification method may further include manipulating a preset button of the image forming apparatus to inform the image forming apparatus that the user confirmed that the image received by the mobile terminal is the same as the security document

In an aspect of one or more embodiments, there is provided an image forming apparatus which includes a scanner to scan a document and create an image, and an NFC tag reader/writer installed in a space inside a cover to cover the document for reading the NFC tag, wherein reading of the NFC tag by the NFC tag reader/writer and scanning of the document by the scanner are simultaneously performed.

In the image forming apparatus, the cover may further include a white sheet serving as a background of the document while the cover is closed and scanning is performed, and the NFC tag reader/writer may be installed in a space behind the white sheet.

In an aspect of or more embodiments, there is provided an image forming apparatus-based security document management system includes an image forming apparatus including a scanner to scan a document and a NFC tag reader/writer to read an NFC tag, and acquiring a 1st S/N, a key value, and a 2nd S/N by reading the NFC tag, a server to receive and store an image of the scanned document and a read result of the NFC tag, and a mobile terminal to communicate with the image forming apparatus and the server and to receive the image of the scanned document and the read result of the NFC tag.

In an image forming apparatus-based security document management system, the 1st S/N may be a unique number of the NFC tag assigned by a manufacturer of the NFC tag.

In an image forming apparatus-based security document management system, the 1st S/N may be a unique number of the NFC tag assigned by a user.

In an image forming apparatus-based security document management system, the key value may be created by combining the 1st S/N with unique feature information of the image forming apparatus.

In an image forming apparatus-based security document management system, the unique feature information of the image forming apparatus may include at least one selected from the group including a serial number of the image forming apparatus, a cumulative number of prints of the image forming apparatus, and creating time information of the security document in the image forming apparatus.

In an image forming apparatus-based security document management system, the key value may be printed on a surface of the security document in at least one form selected from the group including a code including a combination of numbers and characters, a QR code, and a bar code.

In an image forming apparatus-based security document management system, the 2nd S/N may be created by combining the 1st S/N with the key value in accordance with one preset rule.

In an image forming apparatus-based security document management system, the image forming apparatus, the mobile terminal, and the NFC tag reader/writer may communicate with one another using near field communication (NFD).

### BRIEF DESCRIPTION OF THE DRAWINGS

These and/or other aspects of will become apparent and more readily appreciated from the following description of embodiments, taken in conjunction with the accompanying drawings of which:

FIG. 1 is a diagram illustrating an image forming apparatus according to an embodiment;

FIG. 2 is a diagram illustrating a manipulation unit of an image forming apparatus according to an embodiment;

FIG. 3 is a diagram illustrating an image forming apparatus-based security document management system according to an embodiment;

FIG. 4 is a diagram illustrating an installation location of an NFC tag reader/writer of an image forming apparatus according to an embodiment;

FIG. 5 is a diagram illustrating an installation location of an NFC tag reader/writer of an image forming apparatus according to an embodiment;

FIG. 6 is a diagram illustrating an installation location of an NFC tag reader/writer of an image forming apparatus according to an embodiment;

FIG. 7 is a control block diagram illustrating an image forming apparatus according to an embodiment;

FIG. 8 is a diagram illustrating a security document created by an image forming apparatus according to an embodiment;

FIG. 9 is a schematic flowchart illustrating a method of creating/certifying a security document by using an image forming apparatus according to an embodiment;

FIG. 10 is a flowchart illustrating a security document creation process of a method of creating/certifying a security document by using the image forming apparatus illustrated in FIG. 9;

FIG. 11 is a flowchart illustrating a security document certification process of a method of creating/certifying a security document by using the image forming apparatus illustrated in FIG. 9;

FIG. 12 is a flowchart illustrating a method of confirming a key value by using a smart phone of a user in the security document certification process illustrated in FIG. 11;

FIG. 13 is a diagram illustrating a security document created by an image forming apparatus according to an embodiment;

FIG. 14 is a schematic flowchart illustrating a method of creating/certifying a security document by using an image forming apparatus according to an embodiment;

FIG. 15 is a flowchart illustrating a security document creation process of the method of creating/certifying a security document by using the image forming apparatus illustrated in FIG. 14;

FIG. 16 is a flowchart illustrating a security document certification process of the method of creating/certifying a security document by using the image forming apparatus illustrated in FIG. 14;

FIG. 17 is a flowchart illustrating a method of confirming a key value by using a smart phone of a user in the security document certification process illustrated in FIG. 16;

FIG. 18 is a diagram illustrating a security document created by an image forming apparatus according to an embodiment;

FIG. 19 is a schematic flowchart illustrating a method of creating/certifying a security document by using an image forming apparatus according to an embodiment;

FIG. 20 is a flowchart illustrating a security document creation process of the method of creating/certifying a security document by using an image forming apparatus illustrated in FIG. 19;

FIG. 21 is a flowchart illustrating a security document certification process of the method of creating/certifying a security document by using an image forming apparatus illustrated in FIG. 19; and

FIG. 22 is a flowchart illustrating another example of the security document certification process of the method of creating/certifying the security document by using an image forming apparatus illustrated in FIG. 19.

### DETAILED DESCRIPTION

Reference will now be made in detail to embodiments, examples of which are illustrated in the accompanying drawings, wherein like reference numerals refer to like elements throughout.

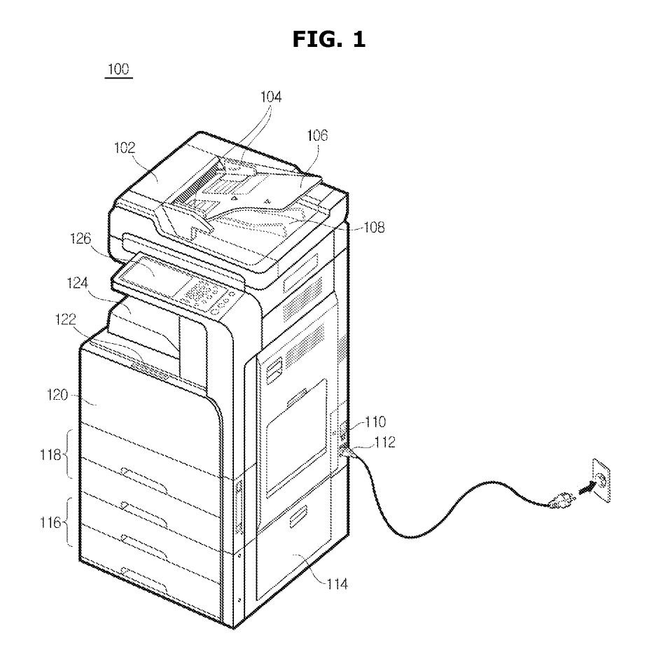

FIG. 1 is a diagram illustrating an image forming apparatus 100 according to an embodiment. Referring to FIG. 1, the image forming apparatus 100 may include the following constituent elements.

An automatic document feeder 102 is mounted at an upper portion of the image forming apparatus 100. The automatic document feeder 102 is optionally installed and may be removed from the image forming apparatus 100. The automatic document feeder 102 may feed multiple pages of a document into the image forming apparatus 100 at a time. For example, when a document with multiple pages is scanned, copied, or transferred (faxed), the multiple pages of the document may quickly be fed into the image forming apparatus 100 by using the automatic document feeder 102. The automatic document feeder 102 includes a document width guide 104, a document feeder tray 106, and a document output tray 108. The document width guide 104 adjusts both sides of a document to be fed (based on a main scanning direction) such that the document is fed into the image forming apparatus 100 in a state of being correctly positioned in a predetermined direction. The document feeder tray 106 is used to accommodate a document to be fed into the image forming apparatus 100. The document accommodated in the document feeder tray 106 may be fed into the image forming apparatus 100 by operation of a paper pickup device, a roller, and the like. The document output tray 108 accommodates the document which is fed from the document feeder tray 106 into the image forming apparatus 100, scanned in the image forming apparatus 100, and output from the image forming apparatus 100.

A power switch 110 is provided at a right side surface of the image forming apparatus 100. The power switch 110 allows a power supply of the image forming apparatus 100 to convert a phase, voltage, or frequency of commercial AC power of 110V or 220V supplied via a power code 112, and supply the converted power into each of the electronic parts of the image forming apparatus 100.

A secondary cassette feeder cover 114 is a cover provided at a side surface of a secondary cassette feeder 116. The secondary cassette feeder 116 may optionally be installed in the image forming apparatus 100 to accommodate paper in addition to a primary cassette feeder 118, which is a basic cassette feeder. The secondary cassette feeder 116 may considerably improve the capacity of accommodating paper together with the primary cassette feeder 118.

A front cover 120 is a cover provided at a front surface of the image forming apparatus 100. For maintenance and repair of a laser scanning unit, a waste toner tank, a toner cartridge, an imaging unit, and the like, the front cover 120 may be opened. The front cover 120 may be opened via a front cover handle 122.

A paper output tray 124 accommodates paper fed into the image forming apparatus 100 and output therefrom after an image is formed on the paper.

A manipulation unit 126 includes a display unit and a status light emitting diode (LED), and a key input unit. In particularly, the key input unit includes a plurality of number buttons, function buttons, menu buttons, and command buttons.

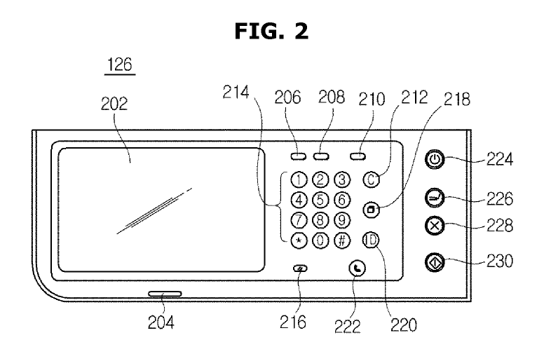

FIG. 2 is a diagram illustrating the manipulation unit 126 of the image forming apparatus 100 according to an embodiment. Referring to FIG. 2, the manipulation unit 126 of the image forming apparatus 100 includes a display unit 202, a status LED 204, an operation status button 206, a counter button 208, a security mode button 210, a delete button 212, number buttons 214, a return button 216, a redial/pause button 218, a log in/out button 220, an on hook dial button 222, a power button 224, an urgent copy button 226, a stop button 228, and a start button 230.

The display unit 202 displays the current status of the image forming apparatus 100 and a screen requiring a response of a user during the operation. In addition, menus may be set by the display unit 202.

The status LED 204 displays the current status of the image forming apparatus 100 via color change and blinking. The display unit 202 is different from the status LED 204, in that the display unit 202 displays detailed status information and enables a two-way communication with the user, and the status LED 204 simply displays the status of the image forming apparatus 100 via only color change and blinking and enables an on-way communication.

The operation status button 206 displays lists of the active, waiting, or completed operations performed in the image forming apparatus 100, errors, or security operations on the display unit 202 in response to a user manipulation.

The counter button 208 displays a cumulative number of paper used in the image forming apparatus 100 in response to a user manipulation.

The security mode button 210 executes a security mode for creation and certification of a security document according to an embodiment.

The delete button 212 deletes characters, numbers, symbols, or the like in an editing area in response to a user manipulation. For example, when a wrong number of copies is entered while performing a copy job, the delete button 212 may be used to correct the number of copies. In addition, when a wrong fax number is entered while performing a fax transmission, the delete button 212 may be used to correct the fax number.

The user may enter a phone number or fax number or input another number or character via the number buttons 214. The number of copies for printing or any other optional number may also be input via the number buttons 214.

The return button 216 initializes the current settings of the image forming apparatus 100 in response to a user manipulation. For example, in a state that a copy job is selected and the number of copies and a copy density (darkness) are set, the number of copies is initialized to 0, and a copy density (darkness) is initialized to a median value by pressing the return button 216.

The redial/pause button 218 redials a recently transmitted or received fax number in a waiting mode or inserts a pause (-) into a fax number during an editing mode in response to a user manipulation.

The log in/out button 220 allows the user to log in the image forming apparatus 100 or log out from the image forming apparatus 100 in response to a user manipulation.

The on hook dial button 222 makes a dial tone sound in response to a user manipulation.

The power button 224 is used to turn on or off the image forming apparatus 100. When the status LED 204 is lit green, the image forming apparatus 100 is in a state of being turned on. To turn off the image forming apparatus 100, the power button 224 is pressed for more than 3 seconds.

The urgent copy button 226 may stop a currently active operation for an urgent copy.

The stop button 228 stops a currently active operation in the image forming apparatus 100 in response to a user manipulation. A pop-up window that shows the contents of the current operation is displayed on the display unit 202 such that the user may select a stop or a restart.

The start button 230 initiates a currently set operation in response to a user manipulation.

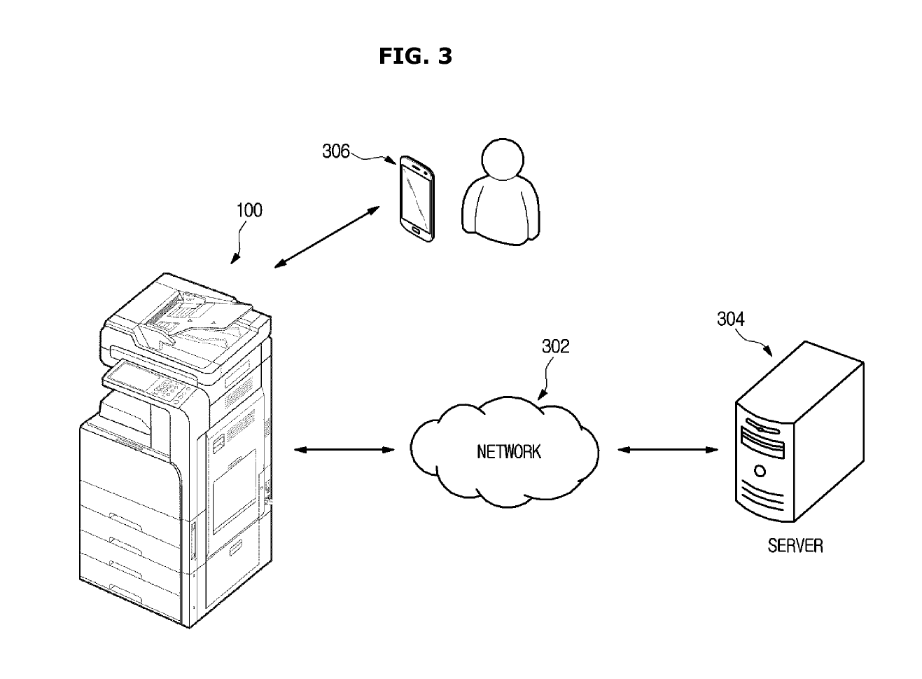

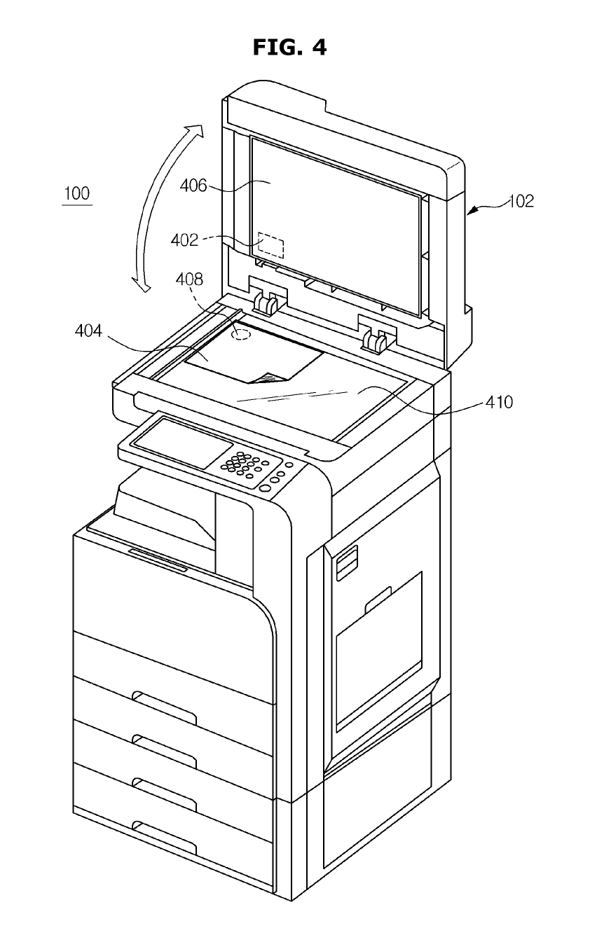

FIG. 3 is a diagram illustrating an image forming apparatus-based security document management system according to an embodiment. Referring to FIG. 3, in the image forming apparatus-based security document management system, the image forming apparatus 100 is connected to a server 304 via a network 302. The server 304 may be a server for data storage. In addition, the server 304 may be replaced with a personal computer (PC), such as desktop, laptop computer, and tablet PC. According to an embodiment, a key value and an image of a security document are stored in the server 304 in a state of corresponding to each other. The key value and the image of the security document stored in the server 304 may be provided to a smart phone 306 of a user via the image forming apparatus 100. The smart phone 306 of the user may communicate with a near field communication (NFC) tag reader/writer 402 (FIG. 4) of the image forming apparatus 100 via NFC or may communicate with an NFC tag of NFC tag embedded/attached security paper or an NFC tag of NFC tag embedded/attached security document. The smart phone 306 is a device, as an example of mobile terminals of a user, and any other portable terminals such as laptop computers, tablet PCs, and mobile phones enabling communications via NFC may also be used in addition to the smart phone 306.

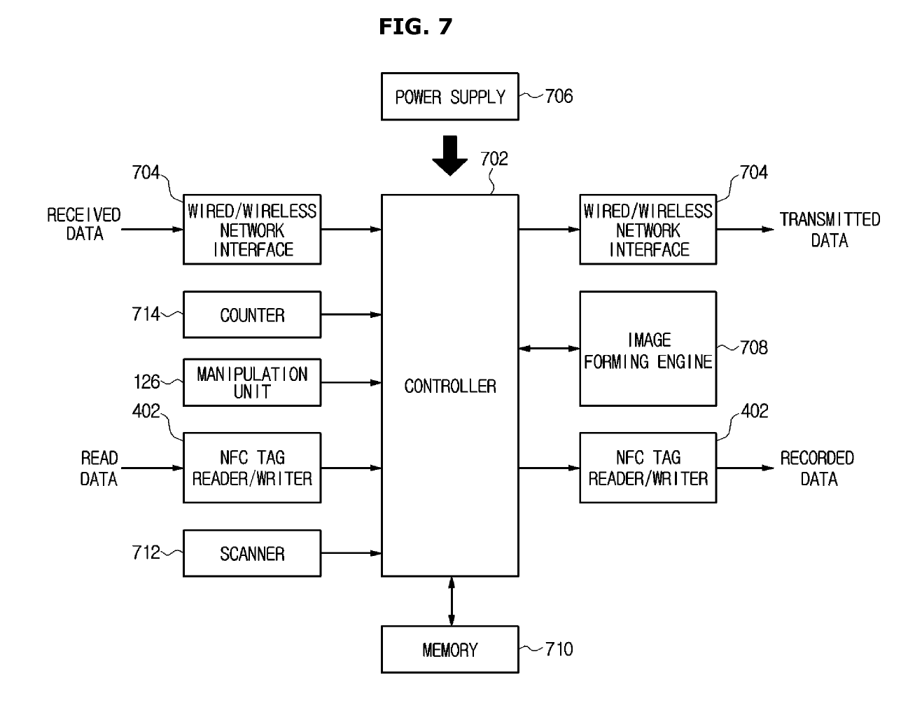

FIG. 4 is a diagram illustrating an installation location of an NFC tag reader/writer of an image forming apparatus according to an embodiment. According to the illustrated embodiment, reading of the NFC tag and scanning of a document need to be performed simultaneously. If the reading of the NFC tag and the scanning of the document are separately performed, an image may be generated by reading the NFC tag, changing the contents of the document, and scanning the document. In this process, the contents of the document may be forged or damaged while maintaining the contents of the NFC tag. Accordingly, according to the illustrated embodiment, the installation location of the NFC tag reader/writer 402 is determined such that the reading of the NFC tag and the scanning of the document are simultaneously performed to inhibit forgery and damage to the contents of the document. To this end, the NFC tag reader/writer 402 of the image forming apparatus may be installed in a space inside a cover to cover a document 404 while scanning the document 404 (In FIG. 4, the automatic document feeder 102 functions as the cover), i.e., at a portion behind a white sheet 406, as illustrated in FIG. 4. The white sheet 406 is provided at the automatic document feeder 102. Since the NFC tag reader/writer 402 communicates with an NFC tag 408 of the document 404 via transmission/reception of radio waves, the NFC tag reader/writer 402 may be installed behind the white sheet 406 to be invisible from the outside. A scanner 712 (FIG. 7) is disposed beneath a flat document glass 410, and the document 404 is placed such that a side of the document 404 to be scanned (a side on which data is recorded) faces toward the upper surface of the flat document glass 410. When the document 404 is disposed as described above, and the white sheet 406 covers the document 404 by lowering the automatic document feeder 102 for scanning, locations of the NFC tag reader/writer 402 and the NFC tag 408 need to correspond to each other such that the NFC tag reader/writer 402 of the white sheet 406 and the NFC tag 408 of the document 404 face each other. Thus, rules may be made such that the locations of the NFC tag reader/writer 402 of the white sheet 406 and the NFC tag 408 of the document 404 correspond to each other in advance, and the rules need to be complied with. As illustrated in FIG. 4, an embedment/attachment location of the NFC tag 408 in the document 404 is determined such that the NFC tag 408 is located at an upper left portion (when the flat document glass 410 is viewed from the front of the image forming apparatus 100) of the flat document glass 410 when the document 404 is placed on the upper surface of the flat document glass 410 for scanning. In an embodiment, the NFC tag 408 is embedded in or attached to the upper left portion of a data recorded side of the document 404. In addition, as illustrated in FIG. 4, the installation location of the NFC tag reader/writer 402 may be a lower left portion of the white sheet 406 (when the white sheet 406 is viewed from the front of the image forming apparatus 100 while the automatic document feeder 201 is lifted up), such that the NFC tag reader/writer 402 of the white sheet 406 and the NFC tag 408 of the document 404 face each other when the white sheet 406 covers the document 404 by lowering the automatic document feeder 102.

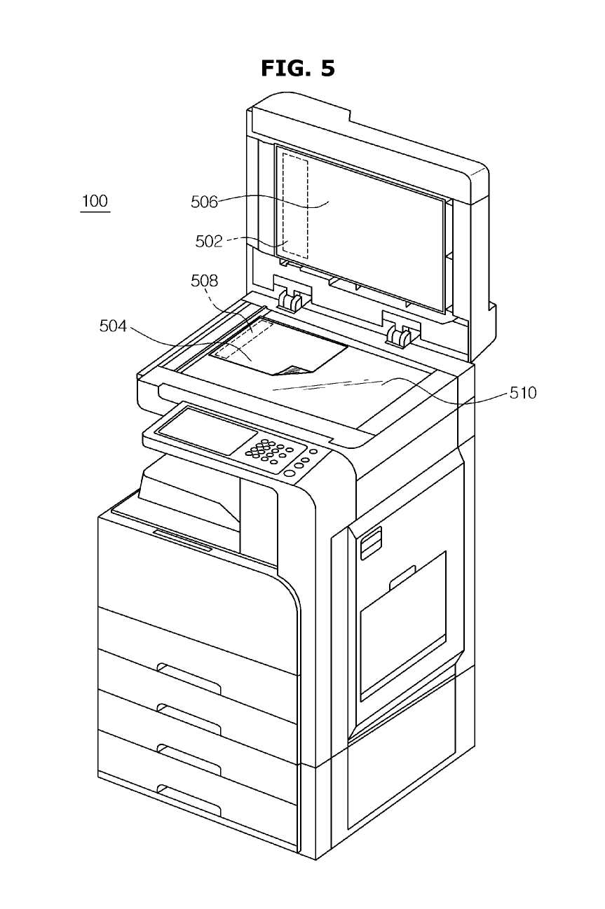

FIG. 5 is a diagram illustrating an installation location of an NFC tag reader/writer of the image forming apparatus 100. As illustrated in FIG. 5, an embedment/attachment location of an NFC tag 508 in a document 504 is determined such that the NFC tag 508 is located at a left portion of a flat document glass 510 (when the flat document glass 510 is viewed from the front of the image forming apparatus 100) when the document 504 is placed on the upper surface of the flat document glass 510 for scanning. In an embodiment, the NFC tag 508 is embedded in or attached to an upper portion of a data recorded side of the document 504. In addition, as illustrated in FIG. 5, the installation location of the NFC tag reader/writer 502 may be a left portion of the white sheet 506 (when the white sheet 506 is viewed from the front of the image forming apparatus 100 while the automatic document feeder 201 is lifted up), such that the NFC tag reader/writer 502 of the white sheet 506 and the NFC tag 508 of the document 504 face each other when the white sheet 506 covers the document 504 by lowering the automatic document feeder 102. According to the embodiment illustrated in FIG. 5, the NFC tag reader/writer 502 may be installed in a long strip shape, and the NFC tag 508 embedded in or attached to the document 504 may also have a long strip shape or may be embedded in or attached to a portion within the long strip shaped area. In an embodiment, the embedment/attachment location of the NFC tag 508 in the document 504 may be relatively freely determined compared to that of FIG. 4.

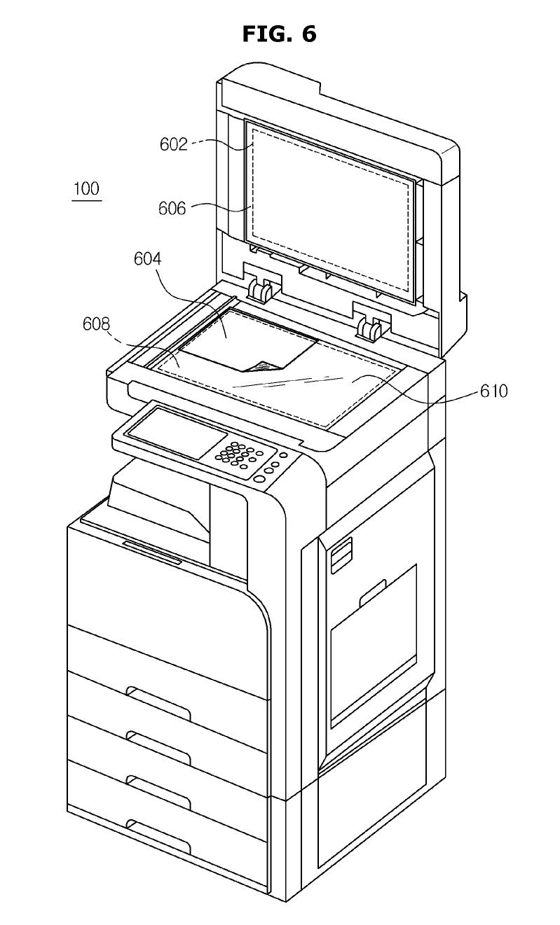

FIG. 6 is a diagram illustrating another installation location of an NFC tag reader/writer of the image forming apparatus 100. Referring to FIG. 6, an NFC tag reader/writer 602 may be installed over the entire surface of a white sheet 606. In an embodiment, a document 604 having all sizes placed on the upper surface of a flat document glass 610 and the entire data recorded surface of the document 604 may be read/recorded by the NFC tag reader/writer 602. Thus, the size of the document 604 and the embedment/attachment location of the NFC tag of the document 604 are not limited. A region 608 marked as dashed lines in FIG. 6 indicates an NFC tag-embeddable/attachable region.

FIG. 7 is a control block diagram illustrating the image forming apparatus 100 according to an embodiment. FIG. 7 illustrates constituent elements of the image forming apparatus 100 such as a wired/wireless network interface 704, a power supply 706, a manipulation unit 126, an NFC tag reader/writer 402, an image forming engine 708, a memory 710, a scanner 712, and a counter 714 disposed around a controller 702 that is involved in the overall operation of the image forming apparatus 100.

When a lot of users share one image forming apparatus 100 via a plurality of host computers in a business space such as an office, the wired/wireless network interface 704 is a communication network interface to allow communications between the image forming apparatus 100 and each of the plurality of host computers. The wired/wireless network interface 704 supports various wired/wireless communications such as wired/wireless LAN communications and wireless communications such as Bluetooth/Wi-Fi. The power supply 706 converts a phase/voltage/frequency, and the like of commercial AC power of 110 V or 220 V and supplies the converted power to each of the electronic parts of the image forming apparatus 100. The image forming engine 708 refers to a constituent element directly involved in a process including supplying paper (or document), performing image processing, and discharging the paper (or document). The memory 710 stores software or firmware required for the controller 702 to control the overall operation of the image forming apparatus 100 and temporarily stores data generated during a control procedure of the image forming apparatus 100. Particularly, the memory 710 stores a variety of data generated during a process of creating or certification of a security document. The scanner 712 refers to a constituent element to scan a document and create an image. As illustrated in FIG. 4, when the automatic document feeder 102 of the image forming apparatus 100 is lifted up, and the flat document glass 410 is shown, the scanner 712 is disposed beneath the flat document glass 410. The scanner 712 scans the document 404 placed on the flat document glass 410, thereby creating image data exhibiting an image of the document 404. The counter 714 counts a total number of pages printed by the image forming apparatus 100 and provides a cumulative total number of printed pages to the controller 702 whenever performing printing. The controller 702 recognizes the number of pages whenever performing printing based on the count value of the cumulative total number of pages received from the counter 714 (on an accumulation basis).

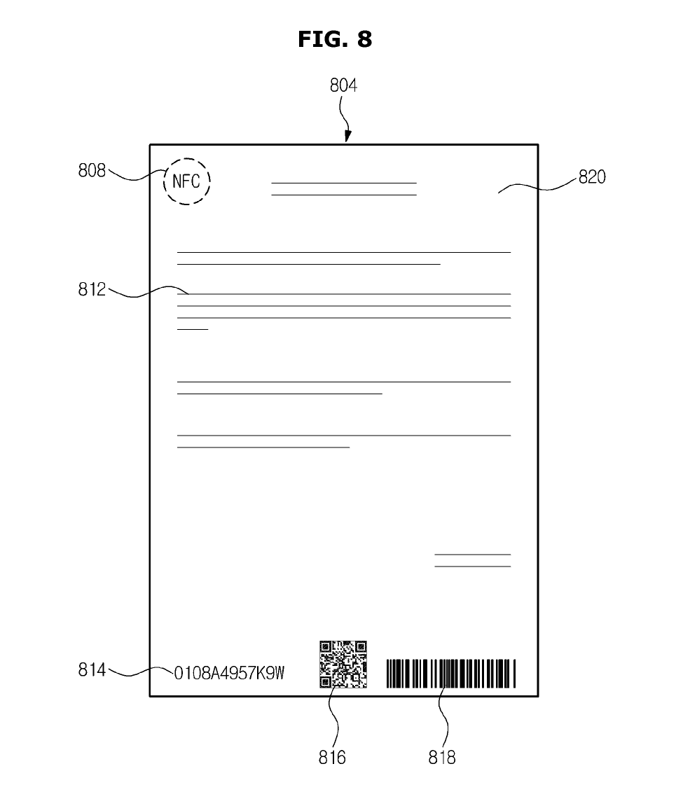

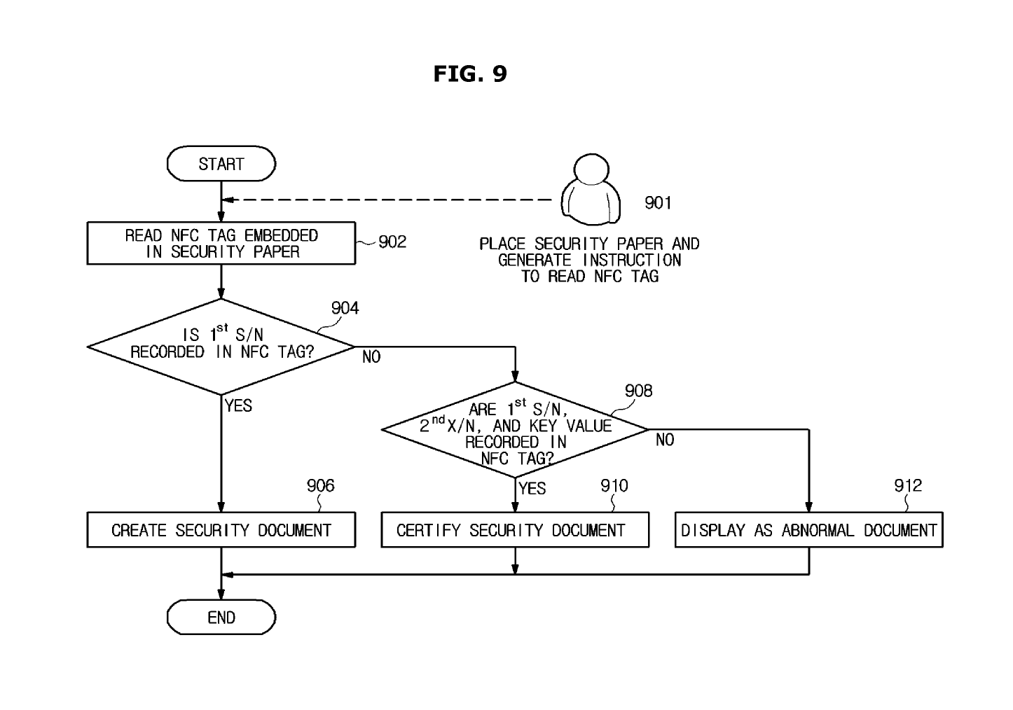

FIG. 8 is a diagram illustrating a security document created by an image forming apparatus according to an embodiment. Referring to FIG. 8, in a security document 804 created according to the illustrated embodiment, data 812 is recorded on NFC tag embedded security paper 820 in which an NFC tag 808 is embedded, and a key value 814 is assigned to the security document 804 for the purpose of security in the image forming apparatus 100. The key value 814 may be a combination of a series of numbers and characters or may be printed as a quick response (QR) code 817 or a bar code 818 as illustrated in FIG. 8. When printed as a quick response (QR) code 816 or the bar code 818, the key value 814 may be read by using a quick response (QR) code reader application or a bar code reader application of the smart phone 306. The first serial number (1st S/N), a key value, and a second serial number (2nd S/N), which are security certification information satisfying requirements of a security document according to the illustrated embodiment, are recorded on the NFC tag 808 of the security document 804 illustrated in FIG. 8. Here, the 1st S/N is a unique number of the NFC tag 808, the key value is a value created by combining multiple feature information of the image forming apparatus 100 in accordance with one preset rule, and the 2nd S/N is a number created by combining the 1st S/N with the key value in accordance with another preset rule. The 1st S/N, as a unique number of the NFC tag 808, may be a number assigned by a manufacturer of the NFC tag 808 during a manufacturing process thereof, or a number arbitrarily assigned to a formatted NFC tag 808 by a user. The multiple feature information of the image forming apparatus 100 for creating the key value may include unique information, such as a serial number, and printing information, such as the number of prints of a current page. The serial number of the image forming apparatus 100 is a unique number assigned thereto by the manufacturer of the image forming apparatus 100. The number of prints of the image forming apparatus 100 is a total number (cumulative value) of pages printed by the image forming apparatus 100, and the number of prints of the current page indicates the total number of pages printed by the image forming apparatus 100 up to the current page. In addition, creating time information of the security document 804 may further be combined with the multiple feature information to create the key value. In this regard, the creating time information of the security document 804 may be time when the 1st S/N of the NFC tag 808 is read or time when the user logs in the image forming apparatus 100 to create the corresponding security document 804. The 1st S/N is a pre-stored value before the security document 804 is created, and the key value and the 2nd S/N are values stored in the NFC tag 808 during a security document creation process. A method of creating/certifying the security document 804 illustrated in FIG. 8 will be described with reference to FIGS. 9 to 12. According to the illustrated embodiment, the 1st S/N, the key value, and the 2nd S/N may respectively be created among data recorded in the NFC tag 808 such that each of the 1st S/N, the key value, and the 2nd S/N to have preset intrinsic features to allow the controller 712 of the image forming apparatus 100 to identify the 1st S/N, the key value, and the 2nd S/N.

In a method of creating/certifying a security document by using the image forming apparatus as illustrated in FIGS. 9 to 12, an empty NFC tag embedded security paper 820 in which an NFC tag embedded and on which no data is recorded is used. A process of creating the security document 804 performed by printing data 812 and the key value 814 on the empty NFC tag embedded security paper 820 and recording security-related information in the NFC tag 808, and a process of certifying the created security document 804 are illustrated in FIGS. 9 to 12.

First, FIG. 9 is a schematic flowchart illustrating a method of creating/certifying a security document by using an image forming apparatus according to an embodiment. Referring to FIG. 9, first, a user places the NFC tag embedded security paper 820 on the scanner 712, and generates an instruction to read an NFC tag (901). To this end, the user places the NFC tag embedded security paper 820 for creation of a security document on the upper surface of the flat document glass 410 of the scanner 712 and lowers the automatic document feeder 102 so that the white sheet 406 covers the NFC tag embedded security paper 820. Data is not recorded on the NFC tag embedded security paper 820, and it is not identified whether the NFC tag embedded security paper 820 is processed for the purpose of security. Then, when the user generates an instruction to read the NFC tag by manipulating the security mode button 210 of the manipulation unit 126, the controller 702 of the image forming apparatus 100 drives the NFC tag reader/writer 402 to read the NFC tag 808 of the NFC tag embedded security paper 820 placed on the flat document glass 410, thereby identifying information recorded in the NFC tag 808 (902). Here, the controller 702 checks whether the 1st S/N that is a unique number of the NFC tag 808 is recorded in the NFC tag 808 (904). When only the 1st S/N is recorded in the NFC tag 808, and the 2nd S/N and the key value are not recorded therein (‘yes’ of operation 904), the controller 702 determines that the NFC tag embedded security paper 820 currently placed on the scanner 712 is not a security document and controls the image forming apparatus 100 to perform a security document creation process (906). Since the fact that only the 1st S/N is recorded in the NFC tag 808 of the security document 820 indicates that the security paper 820 has not undergone the security document creation process, the controller 702 controls the image forming apparatus 100 to perform the security document creation process instead of a security document certification process. On the contrary, when another data in addition to the 1st S/N is recorded in the NFC tag 808, the controller 702 identifies whether the data is the 2nd S/N and the key value (908). The 2nd S/N and the key value are as defined above with reference to FIG. 8. When the 2nd S/N and the key value are recorded in the NFC tag 808 in addition to the 1st S/N (‘yes’ of operation 908), the controller 702 determines that the NFC tag embedded security paper 820 currently placed on the scanner 712 is not empty paper but a security document and controls the image forming apparatus 100 to perform a security document certification process without performing the security document creation process (910). Since the fact that the 2nd S/N and the key value are recorded in the NFC tag 808 in addition to the 1st S/N indicates that the security paper 820 underwent the security document creation process, the controller 702 controls the image forming apparatus 100 to perform the security document certification process instead of the security document creation process. When the 1st S/N is not recorded in the NFC tag 808 (‘no’ of operation 904), and all of the 1st S/N, the 2nd S/N, and the key value are not recorded in the NFC tag 808 (‘no’ of operation 908), the controller 702 determines that the NFC tag embedded security paper 820 currently placed on the scanner 712 is an abnormal document and displays, on the display unit 202, that the NFC tag embedded security paper 820 currently placed on the scanner 712 is an abnormal document (912). In this regard, the ‘abnormal document’ indicates that the document is not subjected to the security document creation/certification process.

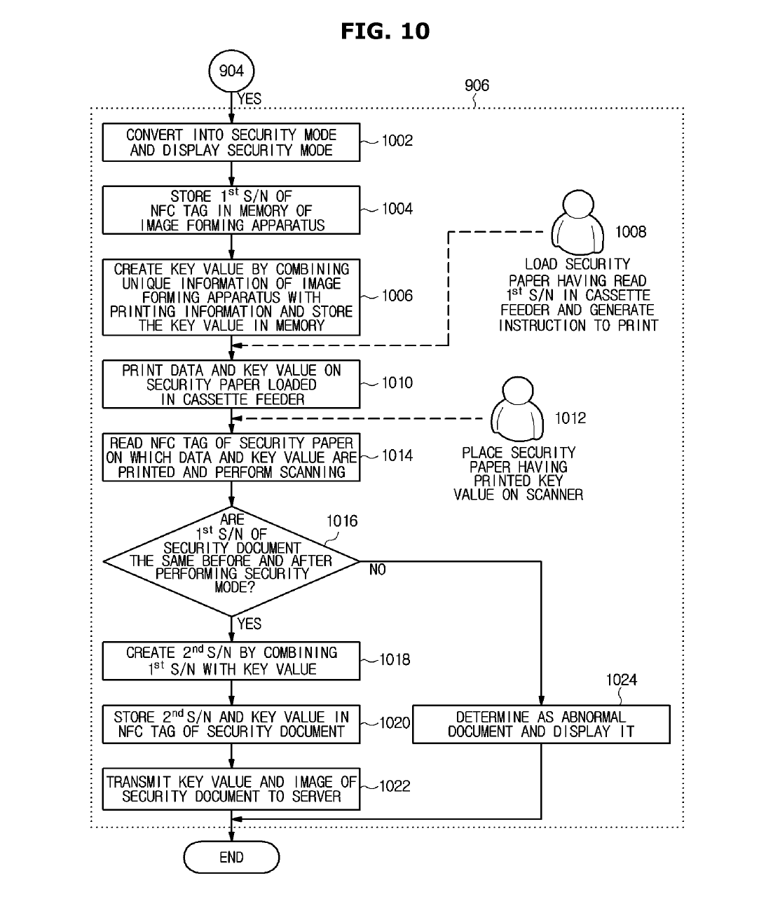

FIG. 10 is a flowchart illustrating a security document creation process of a method of creating/certifying a security document by using the image forming apparatus illustrated in FIG. 9. As described above with reference to operation 904 of FIG. 9, when only the 1st S/N is recorded in the NFC tag 808 of the NFC tag embedded security paper 820, and the 2nd S/N and the key value are not recorded therein (‘yes’ of operation 904), the controller 702 determines that the NFC tag embedded security paper 820 currently placed on the scanner 712 is not a security document and controls the image forming apparatus 100 to perform a security document creation process as illustrated in FIG. 10 (906).

In the security document creation process of operation 906 of FIG. 10, the controller 702 converts an operation mode of the image forming apparatus 100 into a security mode and controls the display unit 20 to display that the current operation mode is the security mode (1002). The user may recognize that the security mode is being performed based on the contents displayed on the display unit 202. Then, the controller 702 temporarily stores the 1st S/N of the NFC tag 808 of the NFC tag embedded security paper 820 read in operation 902 of FIG. 9 in the memory 710 of the image forming apparatus 100 (1004). In addition, the controller 702 combines unique information of the image forming apparatus 100 with printing information thereof to create a key value and stores the created key value in the memory 710 of the image forming apparatus 100 (1006). Here, the unique information of the image forming apparatus 100 is a serial number of the image forming apparatus 100, and the printing information is the number of prints as described above with reference to FIG. 8. In an embodiment, the user prepares for recording of data by loading a primary cassette feeder 118 or a secondary cassette feeder 116 for printing the NFC tag embedded security paper 820 including the NFC tag 808, reading of which is completed, and transmitting data to be recorded on the NFC tag embedded security paper 820 to the image forming apparatus 100 (1008). The controller 702 controls the image forming apparatus 100 such that the NFC tag embedded security paper 820 loaded in the primary cassette feeder 118 or the secondary cassette feeder 116 is output and data and the key value are printed on a data recording side thereof (1010). When the data and the key value are printed on the NFC tag embedded security paper 820, the user places the NFC tag embedded security paper 820 having the data and the key value on the flat document glass 410 of the scanner 712, sets an operation for scanning, and manipulates the start button 230 to prepare for scanning of the NFC tag embedded security paper 820 on which the data and the key value are printed (1012). When an instruction to initiate scanning is generated by manipulating the start button 230, the controller 702 controls the NFC tag reader/writer 402 to read once more the NFC tag 808 of the NFC tag embedded security paper 820 placed on the flat document glass 410 and controls the scanner 710 to scan the data recorded side of the NFC tag embedded security paper 820 and create an image (1014). When the scanning process of the NFC tag embedded security paper 820 on which the data and the key value are printed is completed, the controller 702 compares the 1st S/N of the NFC tag 808 before performing the security mode with that after performing the security mode (1016). That is, the controller 702 determines whether the 1st S/N of the NFC tag 808 read in operation 902 of FIG. 9 is the same as the 1st S/N of the NFC tag 808 read in operation 1014 of FIG. 10. This comparison is performed to confirm whether the NFC tag embedded security paper 820 at the time of reading the 1st S/N of the NFC tag 808 in operation 902 of FIG. 9 is the same as that at the time of reading the 1st S/N of the NFC tag 808 in operation 1014 of FIG. 10. If the 1st S/N of the NFC tag 808 before the security mode is the same as that after the security mode (‘yes’ of operation 1016), the controller 702 combines the 1st S/N of the NFC tag 808 with the key value to create a 2nd S/N (1018). In addition, the controller 702 records the created 2nd S/N in the NFC tag 808 of the NFC tag embedded security paper 820 (1020). Since the data and the key value are printed on the NFC tag embedded security paper 820, and the 1st S/N, the key value, and the 2nd S/N are recorded in the NFC tag 808, one security document 802 is created from the NFC tag embedded security paper 820. The controller 702 transmits the key value and the image of the created security document 804 to the server 304 for storage (1022). When the 1st S/N of the NFC tag 808 before the security mode is different from that after the security mode in operation 1016 as described above (‘no of operation 1016), the controller 702 determines that the NFC tag embedded security paper 820 currently placed on the scanner 712 is an abnormal document and displays, on the display unit 202, that the NFC tag embedded security paper 820 currently placed on the scanner 712 is an abnormal document (1024).

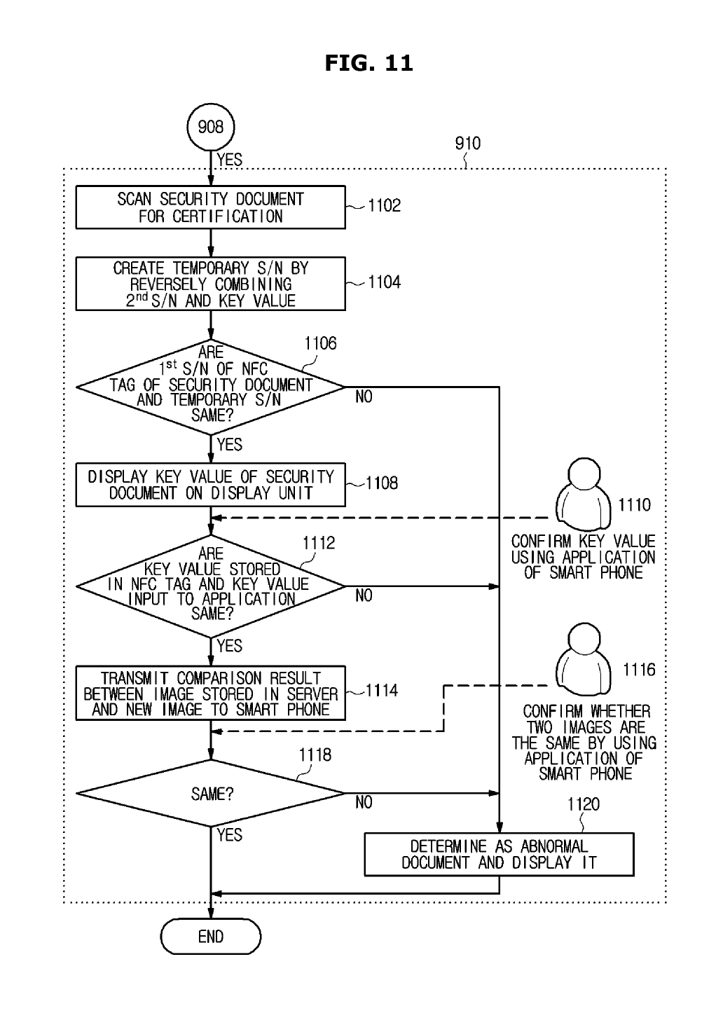

FIG. 11 is a flowchart illustrating a security document certification process of the method of creating/certifying a security document by using an image forming apparatus illustrated in FIG. 9. As described above with reference to operation 904 of FIG. 9, when all of the 1st S/N, the key value, and the 2nd S/N are recorded in the NFC tag 808 of the NFC tag embedded security paper 820 ('yes' of operation 908), the controller 702 determines that the NFC tag embedded security paper 820 currently placed on the scanner 712 is a security document 804 and controls the image forming apparatus 100 to perform a security document certification process as illustrated in FIG. 11 (910).

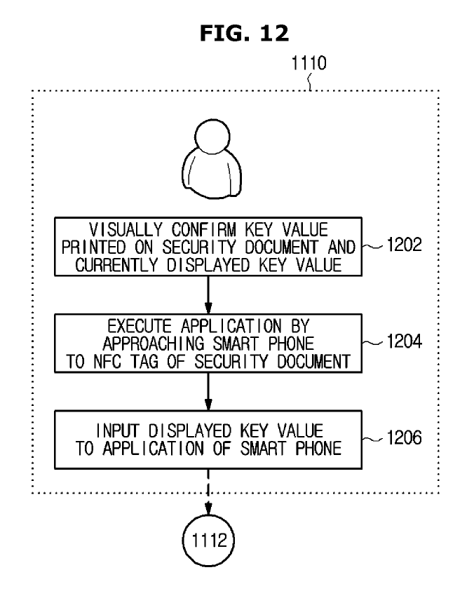

In the security document certification process 910, first, the controller 702 controls the scanner 712 to scan the security document 804 currently placed on the scanner 712, thereby acquiring an image of the security document 804 (1102). When the scanning of the security document 804 is completed, the controller 702 creates a temporary S/N by reversely combining the 2nd S/N with the key value of the security document 804 acquired by reading the NFC tag 808 in operation 908 of FIG. 9 as described above (1104). In this regard, the ‘reverse combination’ of the 2nd S/N with the key value indicates a process of extracting the 1st S/N from the 2nd S/N and the key value by reversely performing the process of creating the 2nd S/N (operation 1018 of FIG. 10) via the ‘combination’ of the 1st S/N and the key value during the security document creation process. The controller 702 compares the 1st S/N of the NFC tag 808 of the security document 804 with the temporary S/N created in operation 1104 (1106). If the 2nd S/N and the key value of the security document 804 are created by a normal process, or data recorded on the NFC tag 808 is not manipulated or damaged after the creation of the security document 804, the 1st S/N of the NFC tag 808 of the security document 804 will be the same as the temporary S/N created in operation 1104. However, on the contrary, if the 2nd S/N and the key value of the security document 804 are created by an abnormal process, or data recorded in the NFC tag 808 is manipulated or damaged after the creation of the security document 804, the 1st S/N of the NFC tag 808 of the security document 804 will be different from the temporary S/N created in operation 1104. When the 1st S/N of the NFC tag 808 of the security document 804 is the same as the temporary S/N created in operation 1104 (‘yes’ of operation 1106), the controller 702 displays the key value of the security document 804 on the display unit 202 to allow the user to confirm the key value (1108). As the controller 702 displays the key value of the security document 804 on the display unit 202, the user may confirm once more authenticity of the security document 804 via the smart phone 306 of the user. That is, the user informs the controller 702 that the user confirmed the key value displayed on the display unit 202 via an application of the smart phone 306 of the user (1110). The confirmation of the key value by the user via the application of the smart phone 306 will be described in more detail with reference to FIG. 12. If the key value acquired by reading the NFC tag 808 of the security document 804 is the same as the key value input to the application of the smart phone 306 of the user (‘yes’ of operation 1112), the controller 702 compares the image of the security document 804 acquired during the security document creation process and stored in the server 304 with the image of the security document 804 acquired by scanning during the security document certification process, and transmits the comparison result to the smart phone 306 of the user to allow the user to confirm the result (1114). In an embodiment, if there is a different portion between the two images, the different portion may be highlighted by using, for example, a red circle or a red border, for easy confirmation thereof by the user. The user confirms that the two images are the same based on the image comparison result transmitted to the smart phone 306 of the user (1116). When the two images are the same, the user informs the controller 702 that the user confirmed that the two images are the same by manipulating a preset button of the image forming apparatus 100 (1118). For example, when the two images are the same, the user may press the security mode button 210 of the manipulation unit 126 once more or may press the start button 230 to inform the controller 702 of as to whether the user confirms that the two images are the same. When it is confirmed that the security document 804 is created by a normal security document creation process through a series of certification processes, the security document certification process is terminated (‘yes’ of operation 1118). However, in the following case, it may be determined that the security document 804 currently undergoing the security document certification process is not created by the normal security document creation process or does not satisfy requirements for the security certification. That is, if the 1st S/N of the NFC tag 808 of the security document 804 is different from the temporary S/N created in operation 1104 (‘no’ of operation 1106), if the key value acquired by reading the NFC tag 808 of the security document 804 is different from the key value input to the application of the smart phone 306 by the user (‘no’ of operation 1112), or if the user refuses to confirm the image since the image of the security document 804 acquired during the security document creation process and stored in the server 304 is different from the image of the security document 804 acquired by scanning during the security document certification process (‘no’ of operation 1118), the controller 702 determines that the security document 804 currently placed on the scanner 712 is an abnormal document and displays, on the display unit 202, that the security document 804 currently placed on the scanner 712 is an abnormal document (1120).

FIG. 12 is a flowchart illustrating a method of confirming a key value by using the smart phone 306 of the user in the security document certification process illustrated in FIG. 11. In operation 1108 of FIG. 11 as described above, when the 1st S/N of the NFC tag 808 of the security document 804 is the same as the temporary S/N created in operation 1104 (‘yes’ of operation 1106), the controller 702 displays the key value of the security document 804 on the display unit 202 to allow the user to confirm the key value. In this regard, the user visually confirms the key value printed on the security document 804 and the key value displayed on the display unit 202 as illustrated in FIG. 12 (1202). When the key value printed on the security document 804 is the same as the key value displayed on the display unit 202, the user approaches the smart phone 306 to the NFC tag 808 of the security document 804 to execute an security certification-related application installed in the smart phone 306 (1204). When the security certification-related application is executed in the smart phone 306, the user inputs the confirmed key value to the application of the smart phone 306 (1206). If the key value is a combination of numbers and characters as illustrated in FIG. 8, the user may input the key value by using a key pad of the smart phone 306. If the key value is a quick response (QR) code 816 or a bar code 818, the user may input the key value by using a QR code reader application or a bar code reader application. To this end, the security certification-related application may be combined with the QR code reader application or the bar code reader application. When the key value is input by the user, the smart phone 306 transmits the key value input by the user to the image forming apparatus 100, and the controller 702 of the image forming apparatus 100 compares the key value acquired by reading the NFC tag 808 of the security document 804 with the key value input to the application of the smart phone 306 by the user as described above in operation 1112 of FIG. 11. If the user does not input the key value to the application of the smart phone 306 for a predetermined period of time, it is determined that the security certification is failed, and accordingly the security document certification process may be forced to end.

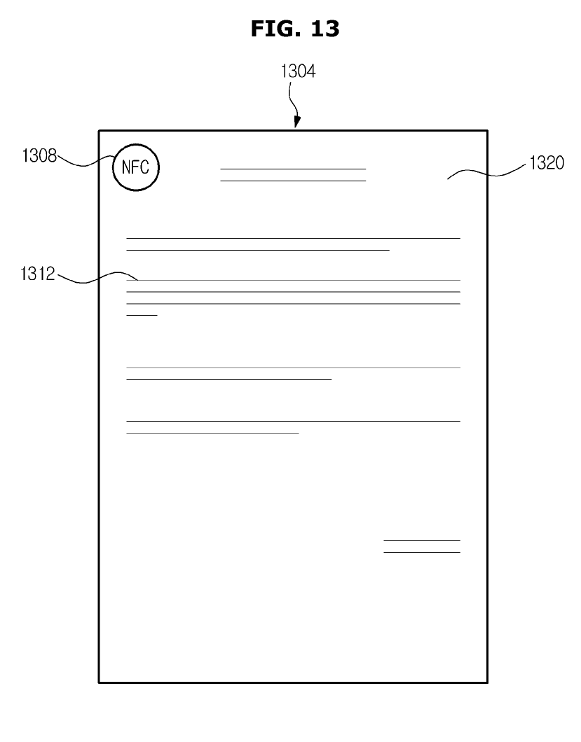

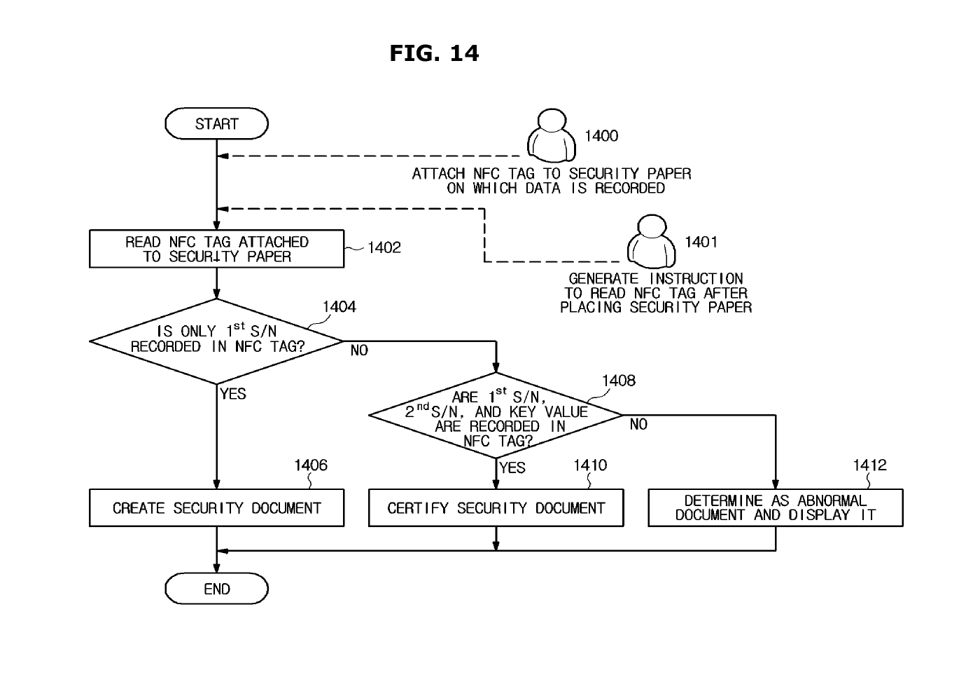

FIG. 13 is a diagram illustrating a security document created by an image forming apparatus according to an embodiment. Referring to FIG. 13, a security document 1304 created according to the illustrated embodiment is based on NFC tag attached security paper 1320 prepared by attaching an NFC tag 1308 to the surface of paper, and recording data 1312 therein. Since the security document 804 of FIG. 8 is created based on the NFC tag embedded security paper 820 in which the NFC tag 808 is embedded as described above, the security document 804 is convenient to use since there is no need to attach a separate NFC tag 1308 as illustrated in FIG. 13. Differently, since the security document 1304 of FIG. 13 is created by attaching a separate NFC tag 1308 on the surface of plain paper, the choice of paper is not limited. In particular, when data is already recorded on plain paper, a security document may be created therefrom by simply attaching the NFC tag 1308 to the paper, and thus the security document 1304 provides advantages different from those of the security document 804 of FIG. 8. A 1st S/N, a key value, and a 2nd S/N, which are security certification information satisfying requirements of a security document according to the illustrated embodiment, are recorded in the NFC tag 1308 of the security document 1304 illustrated in FIG. 13. Here, the 1st S/N is a unique number of the NFC tag 1308, the key value is a value created by combining multiple feature information of the image forming apparatus 100 in accordance with one preset rule, and the 2nd S/N is a number created by combining the 1st S/N with the key value in accordance with another preset rule. The 1st S/N, as a unique number of the NFC tag 1308, may be a number assigned by a manufacturer of the NFC tag 1308 during a manufacturing process thereof, or a number arbitrarily assigned to a formatted NFC tag 1308 by a user. The multiple feature information of the image forming apparatus 100 for creating the key value may include unique information, such as a serial number, and printing information, such as the number of prints of a current page. The serial number of the image forming apparatus 100 is a unique number assigned thereto by the manufacturer of the image forming apparatus 100. The number of prints of the image forming apparatus 100 is a total number (cumulative value) of pages printed by the image forming apparatus 100, and the number of prints of the current page indicates the total number of pages printed by the image forming apparatus 100 up to the current page. In addition, creating time information of the security document 1304 may further be combined with the multiple feature information to create the key value. In this regard, the creating time information of the security document 1304 may be time when the 1st S/N of the NFC tag 1308 is read or time when the user logs in the image forming apparatus 100 to create the corresponding security document 1304. The 1st S/N is a pre-stored value before the security document is created, and the key value and the 2nd S/N are values stored in the NFC tag 1308 during the security document creation process. A method of creating/certifying the security document illustrated in FIG. 13 will be described with reference to FIGS. 14 to 17. According to an embodiment, the 1st S/N, the key value, and the 2nd S/N may respectively be created among data recorded in the NFC tag 1308 such that each of the 1st S/N, the key value, and the 2nd S/N to have preset intrinsic features to allow the controller 712 of the image forming apparatus 100 to identify the 1st S/N, the key value, and the 2nd S/N.

The NFC tag 1308 of FIG. 13 is a sticker-like tag having one adhesive side so as to be easily attached to paper. The sticker-like NFC tag 1308 includes a coil and a chip embedded therein for NFC communications. The NFC tag 1308 of FIG. 13 is configured to disable reattachment thereof to prevent forgery of the security document 1304. That is, when the attached NFC tag 1308 is removed, a particular character, such as ‘security’, is revealed while detaching the NFC tag 1308, and thus it is impossible to detach the attached NFC tag 1308 therefrom and attach another NFC tag 1308 thereto.

In the method of creating/certifying a security document by using the image forming apparatus as illustrated in FIGS. 14 to 17, NFC tag attached security paper 1320 to which an NFC tag is attached and on which data is recorded is used. The security document 1304 is created by recording security related information in the NFC tag 1308 of the NFC tag attached security paper 1320 on which data is already recorded. A process of certifying the created security document 1304 is illustrated in FIGS. 14 to 17.

First, FIG. 14 is a schematic flowchart illustrating a method of creating/certifying a security document by using an image forming apparatus according to an embodiment. Referring to FIG. 14, first, a user attaches a sticker-like NFC tag 1308 to the NFC tag attached security paper 1320 on which data is already recorded (1400). Then, the user places the NFC tag attached security paper 1320 to which the NFC tag 1308 is attached on the scanner 712, and generates an instruction to read an NFC tag (1401). To this end, the user places the NFC tag attached security paper 1320 for creation of a security document on the upper surface of the flat document glass 410 of the scanner 712 and lowers the automatic document feeder 102 so that the white sheet 406 covers the NFC tag attached security paper 1320. Although the NFC tag attached security paper 1320 is paper on which data is recorded and to which the NFC tag 1308 is attached, it is not identified whether the NFC tag attached security paper 1320 is processed for the purpose of security. Then, when the user generates an instruction to read the NFC tag 1308 by manipulating the security mode button 210 of the manipulation unit 126, the controller 702 of the image forming apparatus 100 drives the NFC tag reader/writer 402 to read the NFC tag 1308 of the NFC tag attached security paper 1320 placed on the flat document glass 410, thereby identifying information recorded in the NFC tag 1308 (1402). Here, the controller 702 checks whether the 1st S/N that is a unique number of the NFC tag 1308 is recorded in the NFC tag 1308 (1404). When only the 1st S/N is recorded in the NFC tag 1308, and the 2nd S/N and the key value are not recorded therein (‘yes’ of operation 1404), the controller 702 determines that the NFC tag attached security paper 1320 currently placed on the scanner 712 is not a security document and controls the image forming apparatus 100 to perform a security document creation process (1406). Since the fact that only the 1st S/N is recorded in the NFC tag 1308 of the security document 1320 indicates that the NFC tag attached security paper 1320 has not undergone the security document creation process, the controller 702 controls the image forming apparatus 100 to perform the security document creation process instead of a security document certification process. On the contrary, when another data in addition to the 1st S/N is recorded on the NFC tag 1308, the controller 702 identifies whether the data is the 2nd S/N and the key value (1408). The 2nd S/N and the key value are as defined above with reference to FIG. 13. When the 2nd S/N and the key value are recorded in the NFC tag 1308 in addition to the 1st S/N (‘yes’ of operation 1408), the controller 702 determines that the NFC tag attached security paper 1320 currently placed on the scanner 712 is not empty paper but a security document and controls the image forming apparatus 100 to perform a security document certification process without performing the security document creation process (1410). Since the fact that the 2nd S/N and the key value are recorded in the NFC tag 1308 in addition to the 1st S/N indicates that the NFC tag attached security paper 1320 already underwent the security document creation process, the controller 702 controls the image forming apparatus 100 to perform the security document certification process instead of the security document creation process. When only the 1st S/N is not recorded in the NFC tag 1308, and all of the 1st S/N, the 2nd S/N, and the key value are not recorded in the NFC tag 1308 (‘no’ of operation 1408), the controller 702 determines that the NFC tag attached security paper 1320 currently placed on the scanner 712 is an abnormal document and displays, on the display unit 202, that the NFC tag attached security paper 1320 currently placed on the scanner 712 is an abnormal document (1412). In this regard, the ‘abnormal document’ indicates that the document is not subjected to the security document creation/certification process.

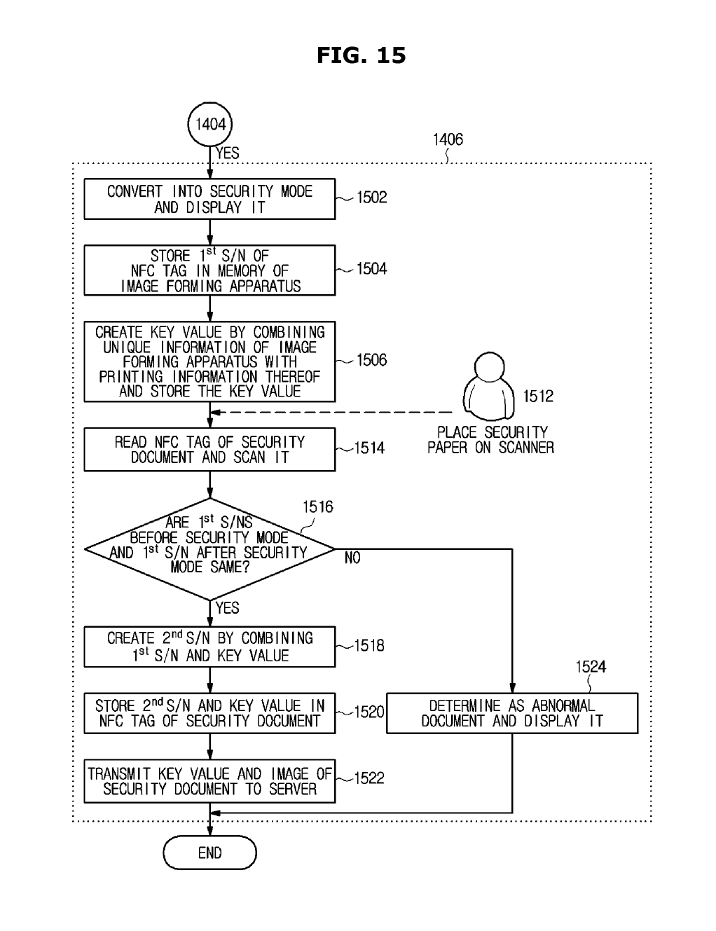

FIG. 15 is a flowchart illustrating a security document creation process of the method of creating/certifying the security document by using the image forming apparatus illustrated in FIG. 14. As described above with reference to operation 1404 of FIG. 14, when only the 1st S/N is recorded in the NFC tag 1308 of the NFC tag attached security paper 1320, and the 2nd S/N and the key value are not recorded therein (‘yes’ of operation 1404), the controller 702 determines that the NFC tag attached security paper 1320 currently placed on the scanner 712 is not a security document and controls the image forming apparatus 100 to perform a security document creation process as illustrated in FIG. 15 (1406). While the security document creation process by using the NFC tag embedded security paper 820 illustrated in FIG. 10 includes a process of printing data and a key value, the security document creation process by using the NFC tag attached security paper 1320 illustrated in FIG. 15 does not require a separate printing process since data is already printed on the NFC tag attached security paper 1320. In addition, if the key value is printed on paper on which data is already printed, the existing data may be damaged. Thus, the key value may not be printed. In addition, in order to print data on paper, the user needs to load paper in the primary cassette feeder 118 or the secondary cassette feeder 116. By omitting the printing process, the user convenience may be improved. If the user needs to load paper in the primary cassette feeder 118 or the secondary cassette feeder 116 in order to print the key value, effects on improvement of the user convenience obtained by not performing the data printing process are negligible. By omitting the printing process of the key value as illustrated in FIG. 15, data is not damaged and the user convenience may further be improved.

In the security document creation process 1406 of FIG. 15, the controller 702 converts an operation mode of the image forming apparatus 100 into a security mode and controls the display unit 20 to display that the current operation mode is the security mode (1502). The user may recognize that the security mode is being performed based on the contents displayed on the display unit 202. Then, the controller 702 temporarily stores the 1st S/N of the NFC tag 1308 of the NFC tag attached security paper 1320 read in operation 1402 of FIG. 14 in the memory 710 of the image forming apparatus 100 (1504). In addition, the controller 702 combines unique information of the image forming apparatus 100 with printing information to create a key value and stores the created key value in the memory 710 of the image forming apparatus 100 (1506). Here, the unique information of the image forming apparatus 100 is a serial number of the image forming apparatus 100, and the printing information is the number of prints as described above with reference to FIG. 13. Then, the user places the NFC tag attached security paper 1320 on the flat document glass 410 of the scanner 712, sets an operation for scanning, and manipulates the start button 230 to prepare for scanning of the NFC tag attached security paper 1320 (1512). When an instruction to initiate scanning is generated by manipulating the start button 230, the controller 702 controls the NFC tag reader/writer 402 to read once more the NFC tag 1308 of the NFC tag attached security paper 1320 placed on the flat document glass 410 and controls the scanner 710 to scan the data recorded side of the NFC tag attached security paper 1320 and create an image (1514). When the scanning process of the NFC tag attached security paper 1320 is completed, the controller 702 compares the 1st S/N of the NFC tag 1308 before performing the security mode with that after performing the security mode (1516). That is, the controller 702 determines whether the 1st S/N of the NFC tag 1308 read in operation 1402 of FIG. 14 is the same as the 1st S/N of the NFC tag 1308 read in operation 1514 of FIG. 15. This comparison is performed to confirm whether the NFC tag attached security paper 1320 at the time of reading the 1st S/N of the NFC tag 1308 in operation 1402 of FIG. 14 is the same as that at the time of reading the 1st S/N of the NFC tag 1308 in operation 1514 of FIG. 15. If the 1st S/N of the NFC tag 1308 before the security mode is the same as that after the security mode ('yes' of operation 1516), the controller 702 combines the 1st S/N of the NFC tag 1308 and the key value to create a 2nd S/N (1518). In addition, the controller 702 records the created 2nd S/N in the NFC tag 1308 of the NFC tag attached security paper 1320 (1520). Since the 1st S/N, the key value, and the 2nd S/N are recorded in the NFC tag 1308 of the NFC tag attached security paper 1320, one security document 1302 is created from the NFC tag attached security paper 1320. The controller 702 transmits the key value and the image of the created security document 1304 to the server 304 for storage (1522). When the 1st S/N of the NFC tag 1308 before the security mode is different from that after the security mode in operation 1516 as described above (‘no of operation 1516), the controller 702 determines that the NFC tag attached security paper 1320 currently placed on the scanner 712 is an abnormal document and displays, on the display unit 202, that the NFC tag attached security paper 1320 currently placed on the scanner 712 is an abnormal document (1524).

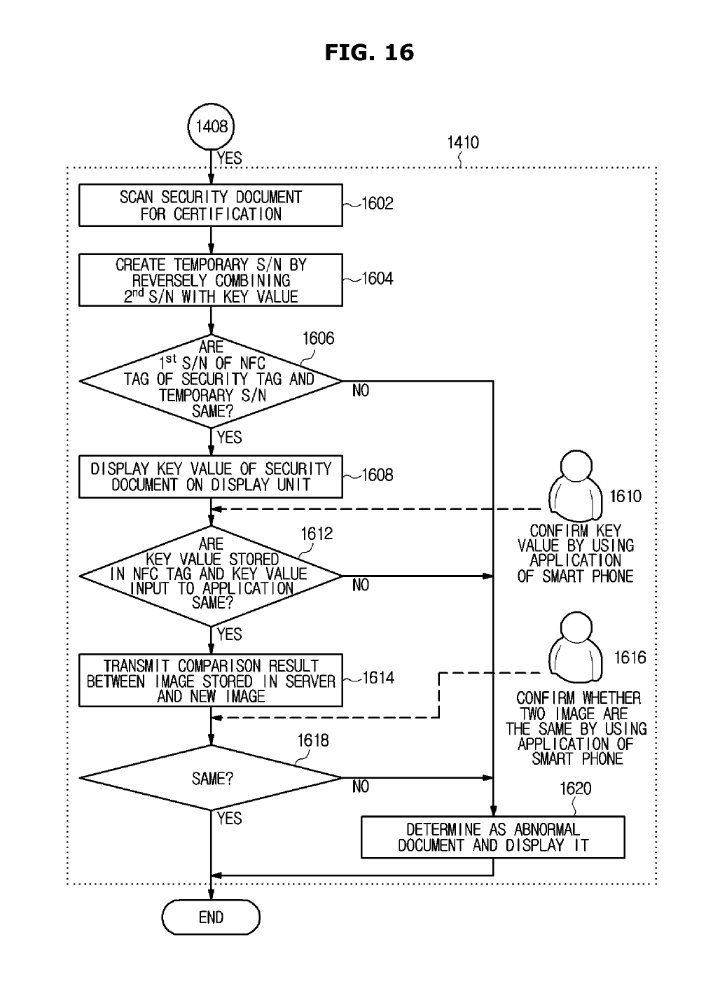

FIG. 16 is a flowchart illustrating a security document certification process of the method of creating/certifying a security document by using the image forming apparatus illustrated in FIG. 14. As described above with reference to operation 1404 of FIG. 14, when all of the 1st S/N, the key value, and the 2nd S/N are recorded in the NFC tag 1308 of the NFC tag attached security paper 1320 (‘yes’ of operation 1408), the controller 702 determines that the NFC tag attached security paper 1320 currently placed on the scanner 712 is a security document and controls the image forming apparatus 100 to perform a security document certification process as illustrated in FIG. 16 (1410).

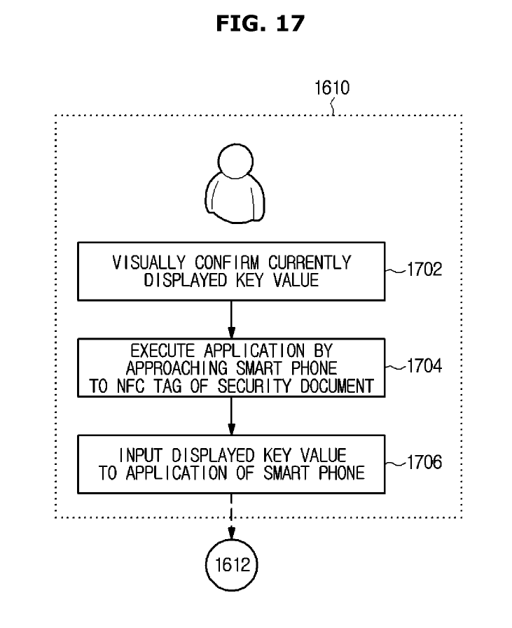

In the security document certification process of operation 1410 of FIG. 16, first, the controller 702 controls the scanner 712 to scan the security document 1304 currently placed on the scanner 712, thereby acquiring an image of the security document 1304 (1602). When the scanning of the security document 1304 is completed, the controller 702 creates a temporary S/N by reversely combining the 2nd S/N with the key value of the security document 1304 acquired by reading the NFC tag 1308 in operation 1408 of FIG. 14 as described above (1604). In this regard, the ‘reverse combination’ of the 2nd S/N with the key value indicates a process of extracting the 1st S/N from the 2nd S/N and the key value by reversely performing the process of creating the 2nd S/N (operation 1518 of FIG. 15) via the ‘combination’ of the 1st S/N and the key value during the security document creation process. The controller 702 compares the 1st S/N of the NFC tag 1308 of the security document 1304 with the temporary S/N created in operation 1604 (1606). If the 2nd S/N and the key value of the security document 1304 are created by a normal process, or data recorded in the NFC tag 1308 is not manipulated or damaged after the creation of the security document 1304, the 1st S/N of the NFC tag 1308 of the security document 1304 will be the same as the temporary S/N created in operation 1604. On the contrary, however, if the 2nd S/N and the key value of the security document 1304 are created by an abnormal process, or data recorded in the NFC tag 1308 is manipulated or damaged after the creation of the security document 1304, the 1st S/N of the NFC tag 1308 of the security document 1304 will be different from the temporary S/N created in operation 1604. When the 1st S/N of the NFC tag 1308 of the security document 1304 is the same as the temporary S/N created in operation 1604 (‘yes’ of operation 1606), the controller 702 displays the key value of the security document 1304 on the display unit 202 to allow the user to confirm the key value (1608). As the controller 702 displays the key value of the security document 1304 on the display unit 202, the user may confirm once more authenticity of the security document 1304 via the smart phone 306 of the user. That is, the user informs the controller 702 that the user confirmed the key value disposed on the display unit 202 via an application of the smart phone 306 of the user (1610). The confirmation of the key value by the user via the application of the smart phone 306 will be described in more detail with reference to FIG. 17. If the key value acquired by reading the NFC tag 1308 of the security document 1304 is the same as the key value input to the application of the smart phone 306 of the user (‘yes’ of operation 1612), the controller 702 compares the image of the security document 1304 acquired during the security document creation process and stored in the server 304 with the image of the security document 1304 acquired by scanning during the security document certification process, and transmits the comparison result to the smart phone 306 of the user to allow the user to confirm the result (1614). In an embodiment, if there is a different portion between the two images, the different portion may be highlighted by using, for example, a red circle or a red border, for easy confirmation thereof by the user. The user confirms whether the two images are the same based on the image comparison result transmitted to the smart phone 306 of the user (1616). When the two images are the same, the user informs the controller 702 that the user confirmed that the two images are the same by manipulating a preset button of the image forming apparatus 100 (1618). For example, when the two images are the same, the user may press the security mode button 210 of the manipulation unit 126 once more or may press the start button 230 to inform the controller 702 of as to whether the user confirms that the two images are the same. After confirming that the security document 1304 is created by a normal security document creation process through a series of certification processes, the security document certification process is terminated (‘yes’ of operation 1618). However, in the following case, it may be determined that the security document 1304 currently undergoing the security document certification process is not created by the normal security document creation process or does not satisfy requirements for the security certification. That is, if the 1st S/N of the NFC tag 1308 of the security document 1304 is different from the temporary S/N created in operation 1604 (‘no’ of operation 1606), if the key value acquired by reading the NFC tag 1308 of the security document 1304 is different from the key value input to the application of the smart phone 306 by the user (‘no’ of operation 1612), or if the user refuses to confirm the image since the image of the security document 1304 acquired during the security document creation process and stored in the server 304 is different from the image of the security document 1304 acquired by scanning during the security document certification process (‘no’ of operation 1618), the controller 702 determines that the security document 1304 currently placed on the scanner 712 is an abnormal document and displays, on the display unit 202, that the security document 1304 currently placed on the scanner 712 is an abnormal document (1620).

FIG. 17 is a flowchart illustrating a method of confirming a key value by using the smart phone 306 of the user in the security document certification process illustrated in FIG. 16. In operation 1608 of FIG. 16 as described above, when the 1st S/N of the NFC tag 1308 of the security document 1304 is the same as the temporary S/N created in operation 1604 (‘yes’ of operation 1606), the controller 702 displays the key value of the security document 1304 on the display unit 202 to allow the user to confirm the key value. In this regard, the user visually confirms the key value displayed on the display unit 202 as illustrated in FIG. 17 (1702). The user approaches the smart phone 306 to the NFC tag 1308 of the security document 1304 to execute a security certification-related application installed in the smart phone 306 (1704). When the security certification-related application is executed in the smart phone 306, the user inputs the confirmed key value to the application of the smart phone 306 (1706). If the key value is a combination of numbers and characters as illustrated in FIG. 13, the user may input the key value by using a key pad of the smart phone 306. If the key value is a QR code 1316 or a bar code 1318, the user may input the key value by using a QR code reader application or a bar code reader application. To this end, the security certification-related application may be combined with the QR code reader application or the bar code reader application. When the key value is input by the user, the smart phone 306 transmits the key value input by the user to the image forming apparatus 100, and the controller 702 of the image forming apparatus 100 compares the key value acquired by reading the NFC tag 1308 of the security document 1304 with the key value input to the application of the smart phone 306 by the user as described above in operation 1612 of FIG. 16. If the user does not input the key value to the application of the smart phone 306 for a predetermined period of time, it is determined that the security certification is failed, and accordingly the security document certification process may be forced to end.

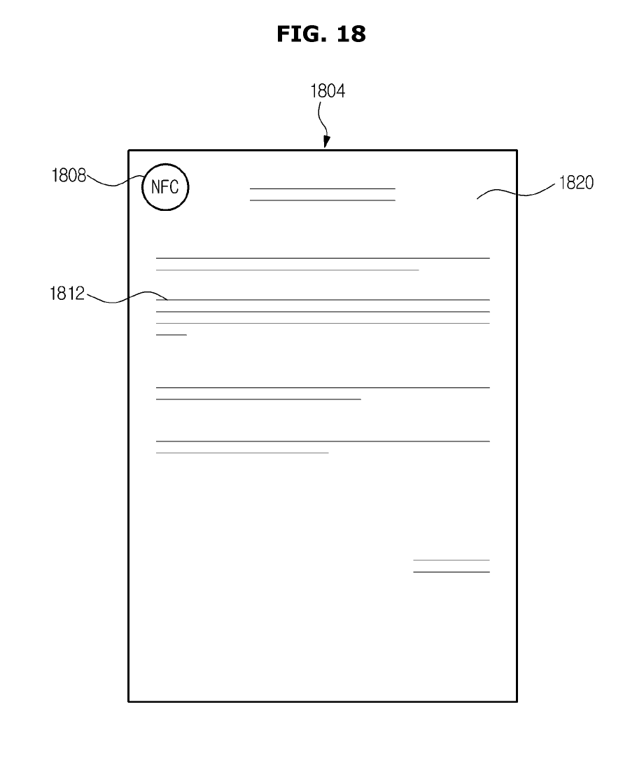

FIGS. 18 to 21 are diagrams illustrating a method of creating/certifying a security document by using an image forming apparatus according to an embodiment. FIGS. 18 to 21 illustrate a simpler method of creating/certifying a security document than the methods as illustrated in FIGS. 8 to 17. According to the method of creating/certifying a security document by using the image forming apparatus as illustrated in FIGS. 18 to 21, NFC tag embedded/attached paper in which an NFC tag is embedded or to which an NFC tag is attached and in which data is recorded may be used.

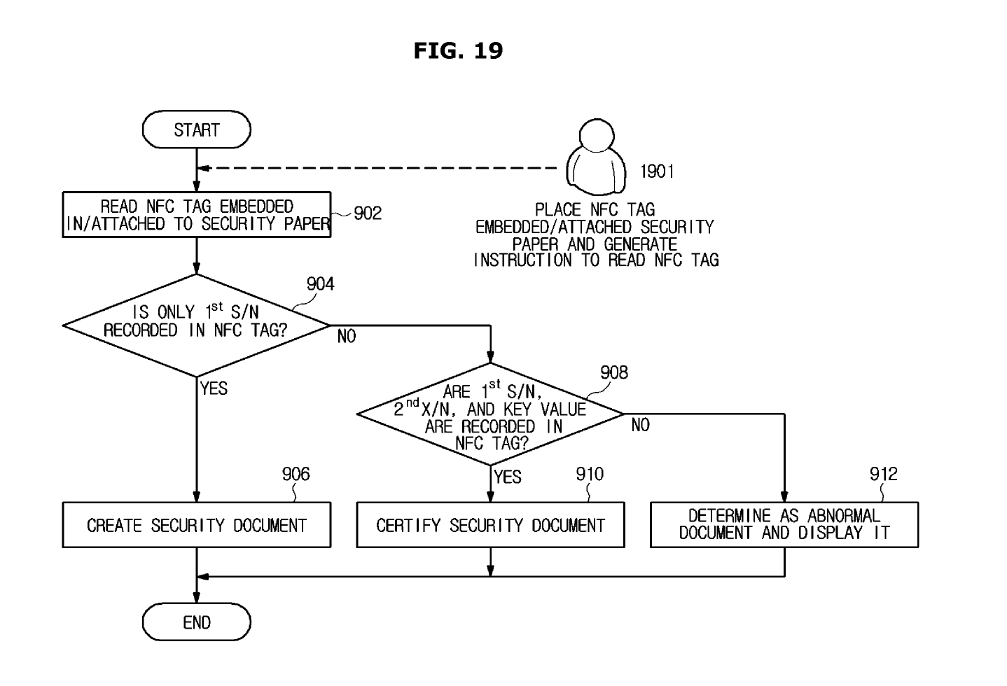

FIG. 18 is a diagram illustrating a security document created by an image forming apparatus according to an embodiment. Referring to FIG. 18, a security document 1804 created according to the illustrated embodiment is based on the NFC tag embedded/attached paper 1820, in which an NFC tag 1808 is embedded or to which the NFC 1808 is attached and in which data 1812 is recorded. A 1st S/N, a key value, and a 2nd S/N, which are security certification information satisfying requirements of a security document according to the illustrated embodiment, are recorded in the NFC tag 1808 of the security document 1804 illustrated in FIG. 18. Here, the 1st S/N is a unique number of the NFC tag 1808, the key value is a value created by combining multiple feature information of the image forming apparatus 100 in accordance with one preset rule, and the 2nd S/N is a number created by combining the 1st S/N with the key value in accordance with another preset rule. The 1st S/N, as a unique number of the NFC tag 1808, may be a number assigned by a manufacturer of the NFC tag 1808 during a manufacturing process thereof, or a number arbitrarily assigned to a formatted NFC tag 1808 by a user. The multiple feature information of the image forming apparatus 100 for creating the key value may include unique information, such as a serial number, and printing information, such as the number of prints of a current page. The serial number of the image forming apparatus 100 is a unique number assigned thereto by the manufacturer of the image forming apparatus 100. The number of prints of the image forming apparatus 100 is a total number (cumulative value) of pages printed by the image forming apparatus 100, and the number of prints of the current page indicates the total number of pages printed by the image forming apparatus 100 up to the current page. In addition, creating time information of the security document 1804 may further be combined with the multiple feature information to create the key value. In this regard, the creating time information of the security document 1804 may be time when the 1st S/N of the NFC tag 1808 is read or time when the user logs in the image forming apparatus 100 to create the corresponding security document 1804. The 1st S/N is a pre-stored value before the security document is created, and the key value and the 2nd S/N are values stored in the NFC tag 1308 during the security document creation process. A method of creating/certifying the security document illustrated in FIG. 18 will be described with reference to FIGS. 19 to 21. According to the illustrated embodiment, the 1st S/N, the key value, and the 2nd S/N may respectively be created among data recorded in the NFC tag 1808 such that each of the 1st S/N, the key value, and the 2nd S/N to have preset intrinsic features to allow the controller 712 of the image forming apparatus 100 to identify the 1st S/N, the key value, and the 2nd S/N.

The NFC tag 1808 of FIG. 18 may be an embedding (embedded) type NFC tag or a sticker-like attachment type NFC tag. If the NFC tag 1808 is a sticker-like attachment type NFC tag, the NFC tag 1808 having one adhesive side may be easily attached to the paper. The sticker-like attachment type NFC tag 1808 includes a coil and a chip embedded therein for NFC communications. The sticker-like attachment type NFC tag 1808 is configured unsuitable for reattachment thereof in order to prevent forgery of the security document 1804. That is, when the attached NFC tag 1808 is removed, a particular character, such as ‘security’, is revealed while detaching the NFC tag 1808, and thus it is impossible to detach the attached NFC tag 1808 therefrom and attach another NFC tag 1808 thereto.

First, FIG. 19 is a schematic flowchart illustrating a method of creating/certifying a security document by using an image forming apparatus according to an embodiment. As illustrated in FIG. 19, the user places the security paper 1820 in which/to which the NFC tag 1808 is embedded/attached and on which data is recorded on the scanner 712, and generates an instruction to read an NFC tag (1901). To this end, the user places the NFC tag embedded/attached security paper 1820 for creation of a security document on the upper surface of the flat document glass 410 of the scanner 712 and lowers the automatic document feeder 102 so that the white sheet 406 covers the NFC tag embedded/attached security paper 1820. Although the NFC tag embedded/attached security paper 1820 is paper on which data is recorded and to which the NFC tag 1808 is attached, it is not identified whether the NFC tag embedded/attached security paper 1820 is processed for the purpose of security. Then, when the user generates an instruction to read the NFC tag 1808 by manipulating the security mode button 210 of the manipulation unit 126, the controller 702 of the image forming apparatus 100 drives the NFC tag reader/writer 402 to read the NFC tag 1808 of the NFC tag embedded/attached security paper 1820 placed on the flat document glass 410, thereby identifying information recorded in the NFC tag 1808 (1902). Here, the controller 702 checks whether the 1st S/N that is a unique number of the NFC tag 1808 is recorded in the NFC tag 1808 (1904). When only the 1st S/N is recorded in the NFC tag 1808, and the 2nd S/N and the key value are not recorded therein ('yes' of operation 1904), the controller 702 determines that the NFC tag embedded/attached security paper 1820 currently placed on the scanner 712 is not a security document and controls the image forming apparatus 100 to perform a security document creation process (1906). Since the fact that only the 1st S/N is recorded in the NFC tag 1808 of the security document 1820 indicates that the NFC tag embedded/attached security paper 1820 has not undergone the security document creation process, the controller 702 controls the image forming apparatus 100 to perform the security document creation process instead of a security document certification process. On the contrary, when another data in addition to the 1st S/N is recorded in the NFC tag 1808, the controller 702 identifies whether the data is the 2nd S/N and the key value (1908). The 2nd S/N and the key value are as defined above with reference to FIG. 18. When the 2nd S/N and the key value are recorded in the NFC tag 1808 in addition to the 1st S/N (‘yes’ of operation 1908), the controller 702 determines that the NFC tag embedded/attached security paper 1820 currently placed on the scanner 712 is not empty paper but a security document and controls the image forming apparatus 100 to perform a security document certification process without performing the security document creation process (1910). Since the fact that the 2nd S/N and the key value are recorded in the NFC tag 1808 in addition to the 1st S/N indicates that the NFC tag embedded/attached security paper 1820 underwent the security document creation process, the controller 702 controls the image forming apparatus 100 to perform the security document certification process instead of the security document creation process. When only the 1st S/N is not recorded in the NFC tag 1808, and all of the 1st S/N, the 2nd S/N, and the key value are not recorded in the NFC tag 1808 (‘no’ of operation 1908), the controller 702 determines that the NFC tag embedded/attached security paper 1820 currently placed on the scanner 712 is an abnormal document and displays, on the display unit 202, that the NFC tag embedded/attached security paper 1820 currently placed on the scanner 712 is an abnormal document (1912). In this regard, the ‘abnormal document’ indicates that the document is not subjected to the security document creation/certification process.

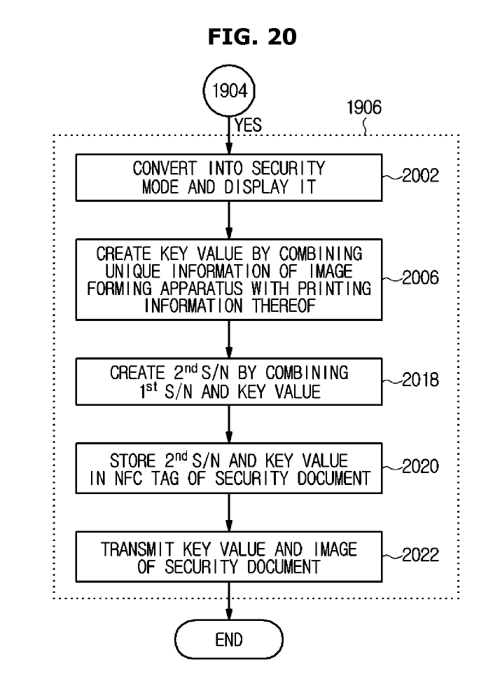

FIG. 20 is a flowchart illustrating a security document creation process of the method of creating/certifying the security document by using the image forming apparatus illustrated in FIG. 19. As described above with reference to operation 1904 of FIG. 19, when only the 1st S/N is recorded in the NFC tag 1808 of the NFC tag embedded/attached security paper 1820, and the 2nd S/N and the key value are not recorded therein ('yes' of operation 1904), the controller 702 determines that the NFC tag embedded/attached security paper 1820 currently placed on the scanner 712 is not a security document and controls the image forming apparatus 100 to perform a security document creation process as illustrated in FIG. 20 (1906). While the security document creation process by using the NFC tag embedded security paper 820 illustrated in FIG. 10 includes a process of printing data and a key value, the security document creation process by using the NFC tag embedded/attached security paper 1820 illustrated in FIG. 20 does not require a separate printing process since data is already printed on the NFC tag embedded/attached security paper 1820. In addition, if the key value is printed on paper on which data is already printed, the existing data may be damaged. Thus, the key value may not be printed. In addition, in order to print data on paper, the user needs to load paper in the primary cassette feeder 118 or the secondary cassette feeder 116. By omitting the printing process, the user convenience may be improved. If the user needs to load paper in the primary cassette feeder 118 or the secondary cassette feeder 116 in order to print the key value, effects on improvement of the user convenience obtained by not performing the data printing process are negligible. By omitting the printing process of the key value as illustrated in FIG. 20, data is not damaged and the user convenience may further be improved.

In the security document creation process 1906 of FIG. 20, the controller 702 converts an operation mode of the image forming apparatus 100 into a security mode and controls the display unit 20 to display that the current operation mode is the security mode (2002). The user may recognize that the security mode is being performed based on the contents displayed on the display unit 202. In addition, the controller 702 combines unique information of the image forming apparatus 100 with printing information to create a key value and stores the created key value in the memory 710 of the image forming apparatus 100 (2006). Here, the unique information of the image forming apparatus 100 is a serial number of the image forming apparatus 100, and the printing information is the number of prints as described above with reference to FIG. 18. The controller 702 creates the 2nd S/N by combining the 1st S/N and the key value of the NFC tag 1808 (2018). In addition, the controller 702 records the created 2nd S/N in the NFC tag 1808 of the NFC tag embedded/attached security paper 1820 (2020). Since all of the 1st S/N, the key value, and the 2nd S/N are recorded in the NFC tag 1808 of the NFC tag embedded/attached security paper 1820, one security document 1802 is created from the NFC tag embedded/attached security paper 1820. The controller 702 transmits the key value and the image of the created security document 1804 to the server 304 for storage (2022). The security document creation process of operation 1906 of FIG. 20, in comparison with the security document creation process of operation 906 of FIG. 10 or the security document creation process of operation 1406 of FIG. 15, does not include a process of loading the NFC tag embedded/attached security paper 1820 in the primary cassette feeder 118 or the secondary cassette feeder 116, a process of printing the key value, a process of placing the NFC tag embedded/attached security paper 1820 on which the key value is printed on the scanner 712, and a process of comparing the 1st S/N before the security mode and that after the security mode. Thus, the security document may be created more simply due to reduced workload of the image forming apparatus 100 and reduced use of paper.

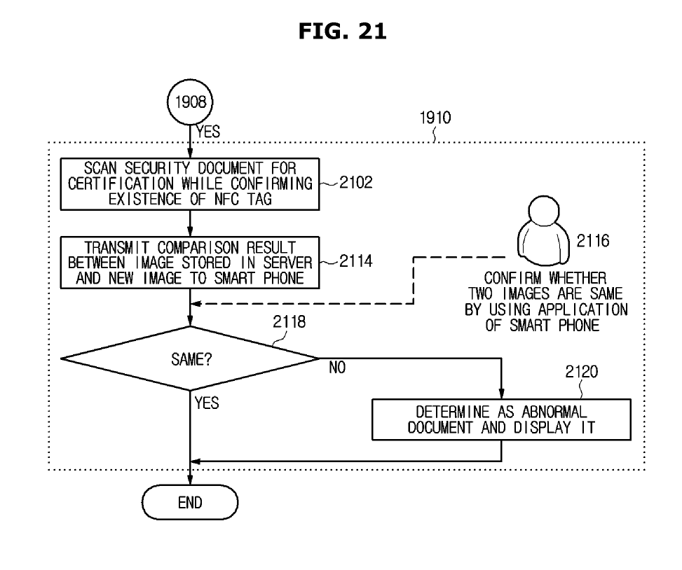

FIG. 21 is a flowchart illustrating a security document certification process of the method of creating/certifying a security document by using the image forming apparatus illustrated in FIG. 19. As described above with reference to operation 1904 of FIG. 19, when all of the 1st S/N, the key value, and the 2nd S/N are recorded in the NFC tag 1808 of the NFC tag embedded/attached security paper 1820 (‘yes’ of operation 1908), the controller 702 determines that the NFC tag embedded/attached security paper 1820 currently placed on the scanner 712 is a security document 1804 and controls the image forming apparatus 100 to perform a security document certification process as illustrated in FIG. 21 (1910).

In the security document certification process 1910 of FIG. 21, first, the controller 702 controls the scanner 712 to scan the security document 1804 currently placed on the scanner 712 while identifying the existence of the NC tag 1808 of the security document 1804, thereby acquiring an image of the security document 1804 (2102). When the scanning of the security document 1804 is completed, the controller 702 compares the image of the security document 1804 acquired during the security document creation process and stored in the server 304 with the image of the security document 1804 acquired by scanning during the security document certification process, and transmits the comparison result to the smart phone 306 of the user to allow the user to confirm the result (2114). In an embodiment, if there is a different portion between the two images, the different portion may be highlighted by using, for example, a red circle or a red border, for easy confirmation thereof by the user. The user confirms whether the two images are the same based on the image comparison result transmitted to the smart phone 306 of the user (2116). When the two images are the same, the user informs the controller 702 that the user confirmed that the two images are the same by manipulating a preset button of the image forming apparatus 100 (2118). For example, when the two images are the same, the user may press the security mode button 210 of the manipulation unit 126 once more or may press the start button 230 to inform the controller 702 of as to whether the user confirmed that the two images are the same. After confirming that the security document 1804 is created by a normal security document creation process through a series of certification processes, the security document certification process is terminated (‘yes’ of operation 2118). However, when the user refuses to confirm the image since the image of the security document 1804 acquired during the security document creation process and stored in the server 304 is different from the image of the security document 1804 acquired by scanning during the security document certification process (‘no’ of operation 2118), the controller 702 determines that the security document 1804 currently placed on the scanner 712 is an abnormal document and displays, on the display unit 202, that the security document 180 currently placed on the scanner 712 is an abnormal document (2120). Since the security document certification process of operation 1910 illustrated in FIG. 21 does not include a process of creating a temporary S/N by reversely combining the 2nd S/N with the key value, a process of comparing the 1st S/N with the temporary S/N, a process of displaying the key value on the display unit 202, and a process of confirming the key value by the user. Thus, the security document may be created more simply due to reduced workload of the image forming apparatus 100 and reduced use of paper.

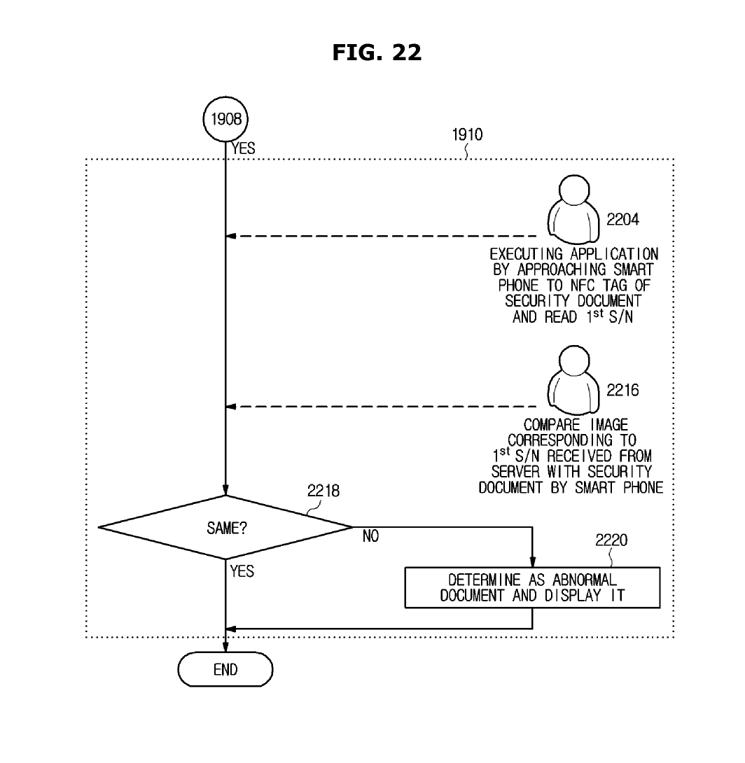

FIG. 22 is a flowchart illustrating another example of the security document certification process of the method of creating/certifying a security document by using the image forming apparatus illustrated in FIG. 19. As described above with reference to operation 1904 of FIG. 19, when all of the 1st S/N, the key value, and the 2nd S/N are recorded on the NFC tag 1808 of the NFC tag embedded/attached security paper 1820 (‘yes’ of operation 1908), the controller 702 determines that the NFC tag embedded/attached security paper 1820 currently placed on the scanner 712 is a security document 1804 and controls the image forming apparatus 100 to perform a security document certification process as illustrated in FIG. 22 (1910).

In the security document certification process of operation 1910 in FIG. 22, the user approaches the smart phone 306 of the user to the NFC tag 1808 of the security document 1804 to execute an application and reads the 1st S/N of the NFC tag 1808 by using the smart phone 306 (2204). The smart phone 306 receives the image corresponding to the 1st S/N of the security document 1804 from the server 304 via communications with the server 304 to allow the user to confirm the image, and the user compares the image transmitted to the smart phone 306 with the actual security document 1804 to confirm whether they are the same (2216). When the image transmitted to the smart phone 306 is the same as the actual security document 1804, the user informs the controller 702 that the user confirmed that the two images are the same by manipulating a preset button of the image forming apparatus 100 (2218). For example, when the image transmitted to the smart phone 306 is the same as the actual security document 1804, the user may press the security mode button 210 of the manipulation unit 126 once more or may press the start button 230 to inform the controller 702 of as to whether the user confirmed that the two images are the same. After confirming that the security document 1804 is created by a normal security document creation process through a series of certification processes, the security document certification process is terminated (‘yes’ of operation 2218). However, when the user refuses to conform the image since the image transmitted to the smart phone 306 is different from the actual security document 1804 (‘no’ of operation 2218), the controller 702 determines that the security document 1804 currently placed on the scanner 712 is an abnormal document and displays, on the display unit 202, that the security document 180 currently placed on the scanner 712 is an abnormal document (2220). According to the security document certification process 1910 illustrated in FIG. 22, workload of the image forming apparatus 100 is minimized. Accordingly, the certification of the security document 1804 may be performed by using a relatively low-performance image forming apparatus 100 without using a high-performance image forming apparatus 100. Instead, by increasing user intervention, reliability of the security document certification process may further be improved due to direct confirmation by the user.

As is apparent from the above description, provided are a security document having with a high level of security fabricated at low cost by using an image forming apparatus-based security document management system including an NFC tag reader/writer, a method of managing a security document, a method of creating a security document, a method of certifying a security document, an image forming apparatus, and the image forming apparatus-based security document management system.

Although a few embodiments have been shown and described, it would be appreciated by those skilled in the art that changes may be made in these embodiments without departing from the principles and spirit of the disclosure, the scope of which is defined in the claims and their equivalents.

What is claimed is:

1. A security document comprising:
an integrated near field communication (NFC) tag,
wherein a first serial number (S/N), a key value, and a second serial number (S/N) are stored as security certification information in the NFC tag.

2. The security document according to claim 1, wherein the first S/N is a unique number of the NFC tag assigned by a manufacturer of the NFC tag.

3. The security document according to claim 1, wherein the first S/N is a unique number of the NFC tag assigned by a user.

4. The security document according to claim 1, wherein the key value is created by combining the first S/N with unique feature information of an image forming apparatus.

5. The security document according to claim 4, wherein the unique feature information of the image forming apparatus comprises at least one selected from the group including a serial number of the image forming apparatus, a cumulative number of prints of the image forming apparatus, and creating time information of the security document in the image forming apparatus.

6. The security document according to claim 4, wherein the key value is printed on a surface of the security document in at least one form selected from the group including a code comprising a combination of numbers and characters, a quick response (QR) code, and a bar code.

7. The security document according to claim 1, wherein the second S/N is created by combining the first S/N with the key value in accordance with one preset rule.

8. The security document according to claim 1, wherein the NFC tag is an embedded type NFC tag.

9. The security document according to claim 1, wherein the NFC tag is an attachment type NFC tag.

10. A method of managing a security document by using an image forming apparatus comprising a near field communication (NFC) tag reader/writer, the method comprising:
reading an integrated NFC tag of security paper comprising the integrated NFC tag by using the NFC tag reader/writer;
performing a security document creation process for the security paper when the first S/N is stored in the NFC tag and both the key value and the second S/N are not stored in the NFC tag; and
performing a security document certification process for the security document when a first serial number (S/N), a key value, and a second (S/N) are all stored in the NFC tag.

11. The method according to claim 10, further comprising generating an image by scanning the security paper by using a scanner when the NFC tag is read by using the NFC tag reader/writer.

12. The method according to claim 10, wherein the first S/N is a unique number of the NFC tag assigned by a manufacturer of the NFC tag.

13. The method according to claim 10, wherein the first S/N is a unique number of the NFC tag assigned by a user.

14. The method according to claim 10, wherein the key value is created by combining the first S/N with unique feature information of the image forming apparatus.

15. The method according to claim 14, wherein the unique feature information of the image forming apparatus comprises at least one selected from the group including a serial number of the image forming apparatus, a cumulative number of prints of the image forming apparatus, and creating time information of the security document in the image forming apparatus.

16. The method according to claim 14, wherein the key value is printed on a surface of the security document in at least one form selected from the group including a code comprising a combination of numbers and characters, a quick response (QR) code, and a bar code.

17. The method according to claim 10, wherein the second S/N is created by combining the first S/N with the key value in accordance with one preset rule.

18. The method according to claim 10, wherein the NFC tag is an embedded type NFC tag.

19. The method according to claim 10, wherein the NFC tag is an attachment type NFC tag.

20. The method according to claim 10, wherein the security document creation process is performed by recording and storing security certification information in the NFC tag of the security paper.

21. The method according to claim 10, wherein the security document certification process is performed by determining authenticity of the security paper by analyzing security certification information stored in the NFC tag of the security paper.

22. The method according to claim 10, further comprising determining that the security document is an abnormal document when at least one selected from the first S/N, the key value, and the second S/N is not stored in the NFC tag.

23. A method of creating a security document by using an image forming apparatus comprising a near field communication (NFC) tag reader/writer, the method comprising:
acquiring a first serial number (S/N) of an NFC tag by reading the NFC tag of a security paper in which the NFC tag is embedded by using the NFC tag reader/writer;
performing a security mode for creating the security document;
creating a key value by combining the first S/N with unique feature information of the image forming apparatus;
printing data and the key value on the security paper;
acquiring the first S/N of the NFC tag by reading the NFC tag of the security paper on which the data and the key value are printed, and creating an image by scanning the security paper;
comparing the first S/N acquired before performing the security mode with the first S/N acquired after performing the security mode;
creating a second S/N by combining the first S/N with the key value when the 1st S/N acquired before performing the security mode is the same as the first S/N acquired after performing the security mode; and
storing the second S/N and the key value in the NFC tag.

24. The method according to claim 23, further comprising loading the security paper in a cassette feeder by a user, and generating an instruction to print data and the key value in the image forming apparatus for printing data and the key value on the security document.

25. The method according to claim 23, further comprising placing the security paper on which the key value is printed on a scanner by a user, and generating an instruction to read the NFC tag in the image forming apparatus.

26. The method according to claim 23, further comprising transmitting the key value and the image to a server.

27. The method according to claim 23, further comprising determining that the security document is an abnormal document when the first S/N acquired before performing the security mode is different from the first S/N acquired after performing the security mode.

28. A method of creating a security document by using an image forming apparatus comprising a near field communication (NFC) tag reader/writer, the method comprising:
acquiring a first serial number (S/N) of an NFC tag by reading the NFC tag of security paper to which the NFC tag is attached and on which data is printed by using the NFC tag reader/writer;
performing a security mode for creating the security document;
creating a key value by combining the first S/N with unique feature information of the image forming apparatus;
acquiring the first S/N of the NFC tag by reading the NFC tag of the security paper, and creating an image by scanning the security paper;
comparing the first S/N acquired before performing the security mode with the first S/N acquired after performing the security mode;
creating a second S/N by combining the first S/N with the key value when the first S/N acquired before performing the security mode is the same as the first S/N acquired after performing the security mode; and
storing the second S/N and the key value in the NFC tag.

29. The method according to claim 28, further comprising placing the security paper on a scanner by a user, and generating an instruction to read the NFC tag in the image forming apparatus.

30. The method according to claim 28, further comprising transmitting the key value and the image to a server.

31. The method according to claim 28, further comprising determining that the security document is an abnormal document when the first S/N acquired before performing the security mode is different from the first S/N acquired after performing the security mode.

32. A method of certifying a security document by using an image forming apparatus comprising near field communication (NFC) tag reader/writer, the method comprising:
reading an integrated NFC tag of the security document comprising the integrated NFC tag by using the NFC tag reader/writer;
scanning the security document;
creating a temporary serial number (S/N) by reversely combining a first S/N, a key value, and a second S/N stored in the NFC tag;
comparing the first S/N with the temporary S/N;
displaying the key value when the first S/N is the same as the temporary S/N;
confirming whether the key value stored in the NFC tag is the same as the displayed key value by using an application of a mobile terminal;
confirming whether an image of the security document stored in a server is the same as an image of the security document acquired by newly scanning the security document, by using an application of the mobile terminal, when the key value stored in the NFC tag is the same as the displayed key value; and
certifying that the security document is an original document when the image of the security document stored in the server is the same as the scanned image of the security document.

33. The method according to claim 32, wherein the confirming of the key value by using the application of the mobile terminal comprises:
confirming the displayed key value by a user;
executing the application by moving the mobile terminal in a direction toward the NFC tag of the security document; and
inputting the displayed key value to the application of the mobile terminal.

34. The method according to claim 33, wherein the confirming of the displayed key value is performed by confirming whether the key value printed on the security document is the same as the displayed key value.

35. The method according to claim 32, wherein the confirming of the key value by using the application of the mobile terminal comprises:
comparing the image of the security document stored in the server with the scanned image of the security document, and marking a different portion using the image forming apparatus; and
transmitting an image, in which the different portion is marked by the image forming apparatus, to the mobile terminal of the user for confirmation by the user.

36. The method according to claim 35, further comprising manipulating a preset button of the image forming apparatus to inform the image forming apparatus that the user confirmed that the image of the security document stored in the server is the same as the scanned image of the security document.

37. A method of creating a security document by using an image forming apparatus comprising a near field communication (NFC) tag reader/writer, the method comprising:
acquiring a first serial number (S/N) of an integrated NFC tag by reading the integrated NFC tag of security paper comprising the integrated NFC tag by using the NFC tag reader/writer;
performing a security mode for creating the security document;
creating a key value by combining the first S/N with unique feature information of the image forming apparatus;
creating a second SN by combining the first S/N with the key value; and
storing the second S/N and the key value in the NFC tag.

38. The method according to claim 37, further comprising transmitting the key value to a server.

39. A method of certifying a security document by using an image forming apparatus comprising a near field communication (NFC) tag reader/writer, the method comprising:
scanning the security document while determining the existence of an integrated NFC tag in the security document comprising the integrated NFC tag;
confirming, by using an application of a mobile terminal, whether an image of the security document stored in a server is the same as an image of the security document acquired by scanning the security document; and
certifying that the security document is an original document when the image of the security document stored in the server is the same as the scanned image of the security document.

40. The method according to claim 39, wherein the confirming of the image by using the application of the mobile terminal comprises:
comparing the image of the security document stored in the server with the scanned image of the security document, and marking a different portion using the image forming apparatus; and
transmitting an image, in which the different portion is marked by the image forming apparatus, to the mobile terminal of a user for confirmation by the user.

41. The method according to claim 40, further comprising manipulating a preset button of the image forming apparatus to inform the image forming apparatus that the user confirmed that the image of the security document stored in the server is the same as the scanned image of the security document.

42. A method of certifying a security document by using an image forming apparatus comprising a near field communication (NFC) tag reader/writer, the method comprising:
acquiring a first serial number (S/N) of an integrated NFC tag by reading the integrated NFC tag of a security document comprising the integrated NFC tag by using a mobile terminal;
scanning the security document to obtain a scanned image of the security document;
receiving an image of the security document stored in a server via an application of the mobile terminal and comparing the image with the security document; and
certifying that the security document is an original document when the image of the security document stored in the server is the same as the scanned image of the security document.

43. The method according to claim 42, further comprising manipulating a preset button of the image forming apparatus to inform the image forming apparatus that a user confirmed that the image received by the mobile terminal is the same as the security document.

44. An image forming apparatus comprising:
a scanner to scan a document and create an image; and
a near field communication (NFC) tag reader/writer installed in a space inside a cover to cover the document for reading the NFC tag, wherein reading of the NFC tag by the NFC tag reader/writer and scanning of the document by the scanner are simultaneously performed.

45. The image forming apparatus according to claim 44, wherein:
the cover further comprises a white sheet serving as a background of the document while the cover is closed and scanning is performed, and
the NFC tag reader/writer is installed in a space behind the white sheet.

46. An image forming apparatus-based security document management system comprising:
an image forming apparatus comprising a scanner to scan a document and a near field communication (NFC) tag reader/writer to read an NFC tag, and acquiring a first S/N, a key value, and a second S/N by reading the NFC tag;
a server to receive and store an image of the scanned document and a read result of the NFC tag; and
a mobile terminal to communicate with the image forming apparatus and the server and to receive the scanned image of the document and the read result of the NFC tag.

47. The image forming apparatus-based security document management system according to claim 46, wherein the first S/N is a unique number of the NFC tag assigned by a manufacturer of the NFC tag.

48. The image forming apparatus-based security document management system according to claim 46, wherein the first S/N is a unique number of the NFC tag assigned by a user.

49. The image forming apparatus-based security document management system according to claim 46, wherein the key value is created by combining the first S/N with unique feature information of the image forming apparatus.

50. The image forming apparatus-based security document management system according to claim 49, wherein the unique feature information of the image forming apparatus comprises at least one selected from the group including a serial number of the image forming apparatus, a cumulative number of prints of the image forming apparatus, and creating time information of the security document in the image forming apparatus.

51. The image forming apparatus-based security document management system according to claim 49, wherein the key value is printed on a surface of the security document in at least one form selected from the group including a code comprising a combination of numbers and characters, a quick response (QR) code, and a bar code.

52. The image forming apparatus-based security document management system according to claim 46, wherein the second S/N is created by combining the first S/N with the key value in accordance with one preset rule.

53. The image forming apparatus-based security document management system according to claim 46, wherein the image forming apparatus, the mobile terminal, and the NFC tag reader/writer communicate with one another using near field communication (NFC).
